(19) United States
(12) Patent Application Publication
(10) Pub. No.: US 2026/0288495 A1
(43) Pub. Date: Sep. 24, 2026

(54) SYSTEM AND METHOD FOR A RESPONSIVE USER INTERACTION

(71) Applicant: eightplus LLC, SACRAMENTO, CA (US)

(72) Inventors: Janesh Ramakrishnan, Sacramento, CA (US); Anand Ramachandran, Mountain View, CA (US); Henry Pham, San Jose, CA (US)

(21) Appl. No.: 19/577,398

(22) Filed: Mar. 25, 2026

Related U.S. Application Data
(63) Continuation-in-part of application No. 19/443,094, filed on Jan. 8, 2026.
(60) Provisional application No. 63/776,193, filed on Mar. 23, 2025.
(60) Provisional application No. 63/952,313, filed on Dec. 31, 2025.

(51) Int. Cl. G06F 9/451

(52) U.S. Cl. CPC G06F 9/451

(57) ABSTRACT

The present invention relates to a system for responsive user interaction. The system comprises a user interface, a detection module, a processing module, and a memory module. The user interface receives content from one or more sources and presents the content to a user. The detection module detects one or more user parameters during interaction of the user with the presented content. The processing module receives the user parameters from the detection module to identify user-state events and classifies them into one or more user-state event types. The memory module persistently stores and updates representations of a state of the user based on at least one of the identified user-state events, the classified user-state event types, associated confidence values, and system-state information. The processing module provides the updated representations from the memory module to one or more responsive components to adapt interaction with the user.

### FIELD OF THE INVENTION

The present invention relates to the field of computer-implemented adaptive learning and intelligent interaction technologies, and more particularly to a system and method for responsive user interaction that adapts content presentation and interaction behaviour in response to dynamically identified user state, enabling timely, context-aware adjustments.

### BACKGROUND

### Interpretation Considerations

This section describes the technical field in detail and discusses the problems encountered in it. Therefore, statements in the section are not to be construed as prior art.

### Discussion

Traditional computerized instructional systems and educational platforms are generally reactive, typically evaluating user performance only after incorrect responses, failed assessments, or observable disengagement. As a result, corrective actions are initiated only after adverse performance outcomes have already manifested, allowing performance difficulties, misconceptions, cognitive overload, and disengagement to develop before any meaningful intervention is attempted fully. This reactive pattern undermines the potential for timely support and often leads to inconsistent or declining user trajectories.

Users exhibit a wide range of cognitive characteristics, comprehension styles, processing speeds, language proficiencies, and interaction behaviors, as well as diverse preferences for audio-based, visual, textual, example-driven, or practice-oriented instructional formats. These differences may arise from variations in prior knowledge, cognitive load tolerance, language fluency, accessibility needs, and individual instructional contexts. Conventional instructional platforms, however, often lack the capacity to continuously detect and respond in real time to emerging user characteristics and preferences, thereby limiting their ability to personalize instruction effectively as users interact with the system.

Existing adaptive instructional systems often rely on aggregate accuracy scores, end-of-unit assessments, or static proficiency models that summarize performance over broad time windows. Such approaches tend to miss subtle, early-stage indicators of emerging difficulty for a user, such as performance instability, oscillatory understanding, engagement variability, missequencing of concepts, or degradation in conceptual coherence. Consequently, remedial actions are often delayed, overly generalized, or misaligned with the true cause of the user's difficulty, reducing their potential impact.

Furthermore, many conventional instructional platforms treat assessment questions as the primary, or even the sole, source of performance signals. In contrast, a user's interactions with explanatory material, summaries, examples, bullet-point overviews, and other non-evaluative instructional elements are underutilized or ignored. This narrow focus limits the system's ability to form a comprehensive, continuous representation of the user's cognitive and engagement states throughout the full instructional experience. As a result, valuable signals embedded in how the user navigates and interacts with content are lost, reducing the richness of the user model and the accuracy of subsequent interventions.

Another persistent limitation of existing instructional systems is the inability to transform large volumes of user interaction data into actionable instructional insights. Educators, platform providers, and institutions often lack visibility into where engagement breaks down for a user, how engagement declines over time, or which specific instructional elements contribute to confusion, cognitive overload, or disengagement. Without such visibility, opportunities to iteratively improve instructional design, accessibility, personalization, and overall user-experience outcomes are often missed, even with detailed behavioral data logs generated by the user.

When conventional systems consider user preferences or interaction modalities, they are usually treated as static labels or self-reported attributes rather than as adaptive, behaviorally validated signals. These preference indicators are rarely refined over time or reconciled with what the user actually does on the platform. As a result, mismatches between content presentation and actual user needs can be misinterpreted as performance difficulties, disengagement, or a lack of aptitude, leading to inappropriate remediation or ineffective instructional adjustments and eroding user trust in the system.

In contrast to closed-loop technical systems, such as medical devices or industrial control systems that continuously sense, detect, and respond to physiological or process signals most instructional platforms lack architectures capable of continuously acquiring multi-modal user performance and interaction signals, conditioning those signals to reduce noise, detecting precursor user states before observable failure, and maintaining an evolving user model that supports anticipatory response. The mechanisms by which instructional interventions are selected, parameterized, and controlled, therefore, remain largely primitive, reactive, or static, with decisions based on limited or delayed information rather than on a rich, dynamic profile of user state and system context.

Accordingly, there is a need for a responsive instructional system and method that continuously acquires and conditions multimodal performance and interaction signals across content units, detects early-stage and precursor user states before adverse outcomes occur, and maintains a dynamic, continuously updated representation of the user's state. Such a platform should support classifiers for distinct user state event types (for example, engagement instability, comprehension difficulty, cognitive overload, attentional drift, memory decay, performance instability, or mastery emergence) and coordinate the delivery of both generative instructional components and non-generative remedial or accessibility interventions in a state-aware manner. By treating intervention delivery as a configurable, closed-loop process, modulating parameters such as explanation depth, pacing, modality emphasis, scaffolding level, and intervention intensity based on evolving user-state and system-state information, the system can mitigate adverse user states before they fully develop, enable more effective and personalized experiences for the user, and continuously refine its intervention strategies based on historical outcomes.

### SUMMARY

An objective of the present invention is to provide a system and method that enable anticipatory, state-aware user interaction by continuously modeling latent cognitive and engagement conditions, rather than reacting only to observable errors or disengagement.

Another objective of the present invention is to provide a system and method that coordinates instructional, remedial, and accessibility responses using a unified, confidence-weighted user-state representation that evolves over time and optionally, spatially.

Yet another objective of the present invention is to provide a system and method that improves learning stability and interaction effectiveness by delivering adaptive interventions at an appropriate timing, intensity, and modality based on detected precursor user-state events.

Still another objective of the present invention is to provide a system and method that drives timely instructional, remedial, or accessibility responses based on evolving user-state events and associated confidence information.

This and other objectives are achieved by providing a system and method for responsive user interaction as defined in the features of the independent claims. Additional advantageous embodiments and improvements of the invention are listed in the dependent claims. The use of expressions like “...aspect according to the invention” or “in one embodiment” or similar terminology is intended to refer to examples or embodiments consistent with the broadest scope of the invention as defined by the independent claims.

According to a first aspect, the present invention discloses a system for responsive user interaction. The system comprises a user interface, a detection module, a processing module, and a memory module. The user interface receives content from one or more content units and presents the content to a user. The detection module detects one or more user parameters during interaction of the user with the presented content. The processing module receives the user parameters from the detection module to identify user-state events. Furthermore, the processing module classifies them into one or more user-state event types. The memory module persistently stores and updates representations of a state of the user based on at least one of the identified user-state events, the classified user-state event types, the progression of user-state events over time, and optionally, spatially associated confidence values and/or system-state information. The processing module provides the updated representations received from the memory module to one or more responsive components to adapt interaction with the user. Therefore, the system enables adaptive interaction by maintaining continuously updated representations of the user's state to drive responsive system behavior.

In an embodiment of the present invention, the content comprises at least one of audio content, video content, textual content, image content, audiovisual content, or a combination thereof. This allows consistent user-state analysis and adaptation across multiple content modalities.

In another embodiment of the present invention, the detection module detects precursor user-state events indicative of a potential future adverse outcome prior to observable failure, disengagement, or performance degradation. This enables earlier intervention by detecting precursor user-state events prior to observable failure or disengagement.

In another embodiment of the present invention, the one or more user parameters include at least one of question-level accuracy, response latency, interaction frequency, content navigation behavior, input modality, user preferences, user rewards/incentives, or explicit user feedback signals. Therefore, improving the reliability of user-state detection by leveraging diverse interaction-level user parameters.

In another embodiment of the present invention, the one or more user state event types include at least one of engagement instability, comprehension difficulty, cognitive overload, attentional drift, memory decay, learning instability, or mastery emergence. Hence, the system enables differentiated responses by categorizing user-state events into distinct cognitive and engagement-related types.

In another embodiment of the present invention, the processing module receives contextual data including at least one of content difficulty metadata, topic or curriculum context, topic or curriculum metadata (type, level, name, categorization), time of day, session duration, device characteristics, environmental characteristics, or user preference indicators. The processing module performs at least one of normalization, temporal windowing, weighting, baseline adjustment, or feature extraction on the user parameters or contextual data prior to identifying user-state events. This thereby improves the accuracy of user-state identification by incorporating contextual data and preprocessing operations.

In yet another embodiment of the present invention, the representations of the state of the user include at least one of cognitive state indicators, mastery progression data, engagement stability measures, preference attributes, predicted outcome indicators, performance history data, detection trace references, or system-state representations. Thus, supporting longitudinal and/or spatial tracking of learning and engagement through multi-dimensional user-state representations.

In yet another embodiment of the present invention, the system-state information includes at least one of previously delivered responsive outputs, history of previously delivered responsive outputs, elapsed time since a prior responsive output, output frequency, output effectiveness, or user response to prior outputs. Thus, it prevents redundant or excessive adaptation by incorporating system-state information that reflects prior responsive outputs.

In yet another embodiment of the present invention, the one or more responsive components comprise a generative instructional component. The processing module adjusts operational parameters of the generative instructional component based on the updated representations, including at least one of the following: explanation depth, verbosity, pacing, modality emphasis, language complexity, scaffolding level, response timing, or instructional framing. Therefore, enabling fine-grained instructional adaptation through dynamic adjustment of generative instructional parameters.

In yet another embodiment of the present invention, the one or more responsive components comprise a non-generative remedial or accessibility intervention engine to deliver interventions based on at least one of the user-state events or the system-state information. Thus, providing responsive assistance through non-generative remedial or accessibility interventions.

In yet another embodiment of the present invention, the processing module coordinates delivery of outputs to both a generative instructional component and a non-generative remedial or accessibility intervention engine. The non-generative remedial or accessibility intervention engine delivers interventions, including at least one of the following: text-to-speech rendering, captioning, visual text extraction, extended-time adjustments, vocabulary assistance, translation, highlighting, annotation tools, summaries, or content restructuring. Hence, the system enables coordinated delivery of instructional and accessibility outputs to provide complementary user support.

In still another embodiment of the present invention, the processing module transforms static or inaccessible content into an interactive, navigable, or annotatable representation presented via the user interface. The transformed content includes visualized or digitized mathematical expressions, numerical relationships, symbolic representations, graphs, or charts. Thereby improving accessibility of static or inaccessible content by transforming it into interactive representations.

In still another embodiment of the present invention, the interventions include attention-regulation tools comprising at least one of interface simplification, screen masking, visual tinting, progressive disclosure, or sequential segmentation. Hence, reducing cognitive load by providing interface-level attention-regulation mechanisms.

In still another embodiment of the present invention, the processing module escalates, maintains, or de-escalates remedial intensity based on changes in the representations of the state of the user over time or space. Therefore, enabling adaptive control of remedial intensity is based on changes in the user's state over time or space.

In still another embodiment of the present invention, the processing module generates or delivers a summary of the presented content in response to detecting at least one user-state event indicative of cognitive overload, learning instability, mastery, or engagement degradation. Thus, the system mitigates cognitive overload and degradation of engagement through responsive content summarization.

In still another embodiment of the present invention, the processing module reorganizes the content into simplified, hierarchical, or segmented representations in response to the detection of a user-state event indicating comprehension difficulty or conceptual fragmentation. Hence, improving comprehension by reorganizing content structure based on detected comprehension-related user-state events.

In still another embodiment of the present invention, at least one of a length, level of detail, abstraction level, or modality of the summary is adjusted based on a confidence value or severity associated with the detected user-state event. Thereby improving comprehension while avoiding unnecessary reduction or overload of information.

In still another embodiment of the present invention, the processing module updates detection sensitivity, thresholds, or conditioning parameters to identify user-state events based on historical user responses to prior responsive outputs and/or prior historical user state events. Thus, enhancing personalization accuracy by adapting detection sensitivity based on historical user responses.

According to a second aspect, the present invention discloses a system for determining a user state representation. The system comprises a detection module, a processing module, and a memory module. The detection module acquires user parameters from user interactions with one or more content units. The processing module receives the user parameters from the detection module to identify user-state events. Furthermore, the processing module classifies the user-state events into one or more user-state event types. The memory module to persistently store and update representations of a state of the user based on at least one of the identified user-state events, the classified user-state event types, associated confidence values, or system-state information. The processing module provides the updated representations from the memory module to a profile framework. This enables proactive interventions by detecting precursor states before adverse outcomes, unlike reactive systems.

According to a third aspect, the present invention discloses a system for state-driven reconfiguration of responsive components. The system comprises a detection module, a processing module, and a memory module. The detection module detects one or more user parameters during user interaction with presented content. The processing module receives the user parameters from the detection module to identify user-state events. Furthermore, the processing module classifies the user-state events into one or more user-state event types with associated confidence values. The memory module stores user-state representations and system-state information. The processing module selects a response-configuration parameter based on at least one of the user-state representations or system-state information and provides the selected response-configuration parameter to one or more responsive components configured to adjust operational settings. This enables precise, state-aware adaptation of interventions such as LLM parameters or accessibility tools, optimizing effectiveness while avoiding over-remediation.

In an embodiment of the present invention, the response-configuration parameter includes at least one of content modality emphasis, content complexity level, pacing rate, scaffolding intensity, feedback granularity, repetition frequency, or sequencing flexibility. This provides targeted subspace constraints for state-driven responses, enabling nuanced personalization beyond binary remediation.

In an embodiment of the present invention, the operational settings include at least one of generative model inference parameters, prompt conditioning attributes, output formatting controls, intervention timing constraints, remedial action intensity levels, token constraints, hyper-parameters, accessibility feature activations, or attention-regulation tool configurations. This supports seamless integration with LLMs/AI Agents and accessibility engines, dynamically optimizing both generative and non-generative interventions.

### BRIEF DESCRIPTION OF DRAWINGS

The drawings illustrate the design and utility of embodiments of the present invention, in which common reference numerals refer to similar elements. To better appreciate the advantages and objects of the embodiments of the present invention, reference should be made to the accompanying drawings that illustrate these embodiments. However, the drawings depict only some embodiments of the invention and should not be taken as limiting its scope. Various aspects, as well as embodiments of the present invention, are better understood by referring to the following detailed description. To better understand the invention, the detailed description should be read in conjunction with the drawings. With this caveat, embodiments of the invention will be described and explained with additional specificity and detail through the use of the accompanying drawings in which:

FIG. 1(A) illustrates a system for responsive user interaction in accordance with an exemplary embodiment of the present invention;

FIG. 1(B) illustrates a system for responsive user interaction in accordance with another exemplary embodiment of the present invention;

FIG. 2 illustrates an architecture for capturing and organizing user interaction and content metadata in accordance with an exemplary embodiment of the present invention;

FIG. 3 illustrates a processing module in accordance with an exemplary embodiment of the present invention;

FIG. 4 illustrates a memory module in accordance with an exemplary embodiment of the present invention;

FIG. 5 illustrates a generative instructional component control architecture in accordance with an exemplary embodiment of the present invention;

FIG. 6 illustrates a non-generative remedial engine in accordance with an exemplary embodiment of the present invention;

FIG. 7 illustrates a static content transformation subsystem within a remedial engine in accordance with an exemplary embodiment of the present invention;

FIG. 8 illustrates a flow diagram depicting a method for responsive user interaction in accordance with an exemplary embodiment of the present invention;

FIG. 9 illustrates a user interface presenting instructional content associated with a topic, together with accessibility controls that enable adjustment of visual presentation parameters in accordance with an exemplary embodiment of the present invention;

FIG. 10 illustrates a user interface that enables adaptive interaction, in which instructional content is presented together with a transformation panel and an adaptive quiz to evaluate user comprehension, in accordance with an exemplary embodiment of the present invention;

FIG. 11 illustrates question generation on a user interface that provides multiple questions of varying difficulty levels and optional answer-reveal controls in accordance with an exemplary embodiment of the present invention;

FIG. 12 illustrates a prerequisite review on a user interface that presents prerequisite concepts and quick-review modules associated with a selected topic in accordance with an exemplary embodiment of the present invention;

FIG. 13 illustrates rewards and incentives on a user interface that presents achievements, progress indicators, and redeemable rewards associated with user interaction with the learning system, in accordance with an exemplary embodiment of the present invention;

FIG. 14 illustrates a flashcard interaction in a user interface that presents flashcards for rapid review of key concepts in accordance with an exemplary embodiment of the present invention;

FIG. 15 illustrates a deep-dive exploration of a user interface that expands on a selected concept by providing additional explanatory content and visual representations in accordance with an exemplary embodiment of the present invention;

FIG. 16 illustrates a concept map of a user interface that graphically represents relationships among multiple concepts associated with a selected topic in accordance with an exemplary embodiment of the present invention;

FIG. 17 illustrates a user interface, presenting structured comparisons between related concepts in accordance with an exemplary embodiment of the present invention; and

FIGS. 18(A) and 18(B) illustrate a multimodal transformation presented on a user interface, providing alternative representations of instructional content, including summaries, bullet points, visualizations, and analogy-based explanations, in accordance with an exemplary embodiment of the present invention.

### DETAILED DESCRIPTION

The present disclosure is best understood with reference to the detailed figures and description set forth herein. Various embodiments have been discussed with reference to the figures. However, a person skilled in the art will readily appreciate that the detailed descriptions provided herein with respect to the figures are merely for explanatory purposes, as the methods and system may extend beyond the described embodiments. For instance, the teachings presented and the needs of a particular application may yield multiple alternatives and suitable approaches to implement the functionality of any detail described herein. Therefore, any approach may extend beyond certain implementation choices in the following embodiments.

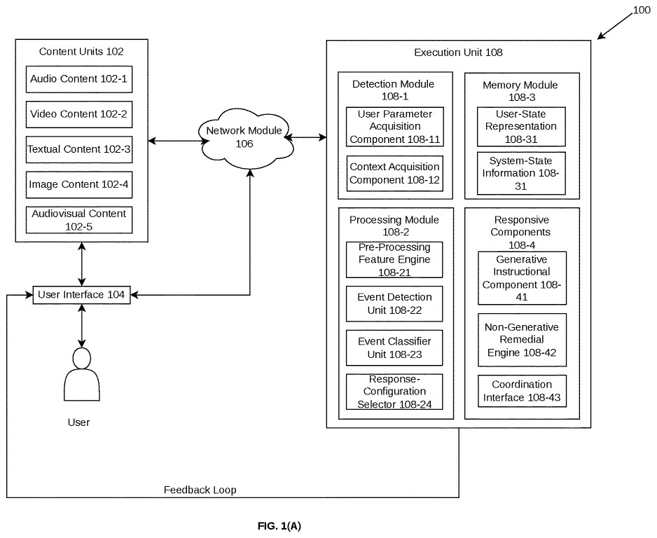

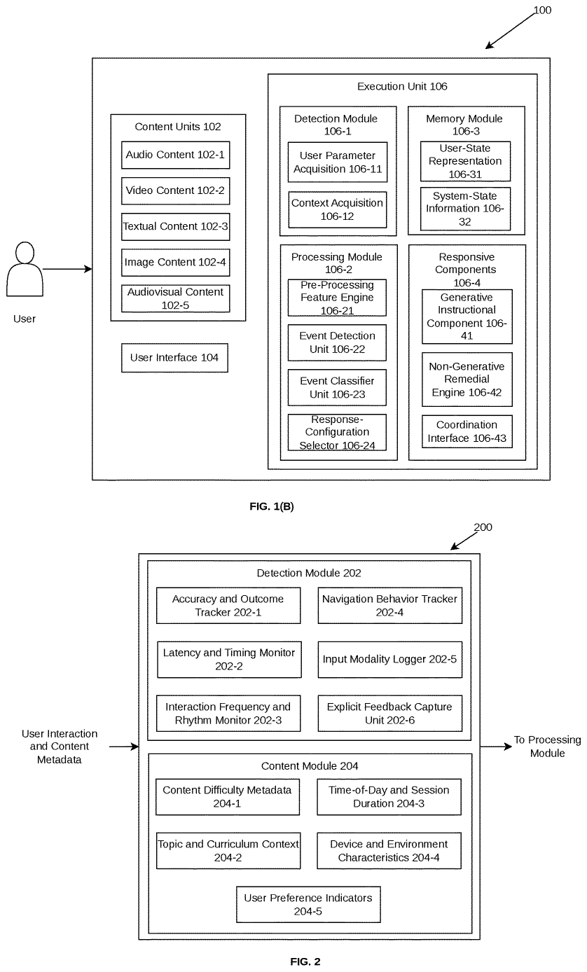

Specific embodiments of the present invention will now be described in detail with reference to the accompanying FIGS. 1-18. In the following detailed description, numerous specific details are outlined to provide a thorough understanding of the invention. However, those skilled in the art will understand that the invention may be practiced without these specific details. In other instances, well-known structures, components, and processes have not been described in detail to avoid obscuring the invention.

The figures illustrate the architecture, functionality, and operation of possible implementations of systems, methods, and computer program products in accordance with various embodiments of the present invention. In this regard, each block in the figures may represent a module, segment, or portion of instructions that comprises one or more executable instructions for implementing specified logical functions. It should also be noted that, in some alternative implementations, the functions noted in the blocks may occur out of the order illustrated in the figures. For example, two blocks shown in succession may, in fact, be executed substantially concurrently, or the blocks may sometimes be executed in reverse order, depending upon the functionality involved.

Since various possible embodiments of the invention may be proposed and modifications may be made to the embodiments described herein, it is to be understood that all matters described in this specification or shown in the accompanying drawings are to be interpreted as illustrative and not in a limiting sense. Thus, it will be understood by those skilled in the art that although preferred and alternative embodiments have been described in accordance with applicable patent statutes, the invention is not limited thereto.

FIG. 1(A) illustrates a system 100 for responsive user interaction in accordance with an exemplary embodiment of the present invention. The system 100 is configured to detect user-state events during interaction with the presented content and dynamically adapt system responses based on detected user conditions. The system 100 may provide responsive interaction in environments such as educational platforms, training systems, assistive learning tools, productivity environments, or other interactive digital systems.

The system 100 includes one or more content units 102, a user interface 104, a network module 106, and an execution unit 108. These components cooperate to detect signals indicative of the user's cognitive or behavioral state and adapt interaction with the user accordingly.

The architecture illustrated in FIG. 1(A) may operate as a closed-loop adaptive system 100, in which responses generated by the system 100 influence subsequent user interactions and therefore influence future detection and adaptation processes.

Conventional adaptive learning systems rely primarily on post-performance indicators, such as accuracy scores or assessment outcomes, which may reflect learning failures only after they occur. In contrast, the system described herein improves the functioning of computer-based interaction systems by enabling early detection of user-state events through multi-signal behavioral analysis performed during ongoing interaction with presented content. By detecting precursor interaction patterns and dynamically reconfiguring responsive components in real time, the system 100 reduces computational inefficiencies associated with delayed remediation. It improves the responsiveness and stability of interactive content delivery systems.

The content units 102 provide content that is presented to a user through the user interface 104. The content units 102 may include multiple forms of digital content, including, but not limited to, audio content 102-1, video content 102-2, textual content 102-3, image content 102-4, and audiovisual content 102-5. These various content modalities may be delivered individually or in combination, depending on the instructional context.

As used herein, the term “learning content unit” or “content units 102” may refer to any discrete instructional element presented to the user, including questions, exercises, lessons, explanations, multimedia content, or other instructional material.

The audio content 102-1 may include spoken explanations, narrations, lectures, or auditory guidance. The video content 102-2 may include instructional videos, demonstrations, simulations, or recorded lessons. The textual content 102-3 may include reading passages, instructions, exercises, questions, or explanations. The image content 102-4 may include diagrams, graphs, charts, symbolic expressions, or illustrations. The audiovisual content 102-5 may include multimedia presentations combining synchronized audio and visual information.

In one case, the content units 102 may include educational course materials stored locally on a computing device. In another case, the content units 102 may correspond to remote content repositories such as digital libraries, cloud-based educational systems, learning management platforms, or streaming media systems. In yet another case, the content units 102 may include dynamically generated instructional materials produced by generative models.

The system 100 may also transform static or inaccessible content into interactive or accessible formats. For example, scanned documents may be converted into structured text, mathematical expressions may be digitized into symbolic representations, or static diagrams may be converted into interactive graphical elements.

The user interface 104 presents content received from the content units 102 and enables interaction between the user and the system 100. The user interface 104 may include both output components and input components that enable the presentation of information and the capture of user interaction signals.

The output components of the user interface 104 may include, but are not limited to, display screens, speakers, projection systems, or augmented reality displays. The input components may include, but are not limited to, keyboards, touchscreens, stylus input devices, microphones, cameras, gesture sensors, or other input mechanisms.

The user interface 104 may allow the user to interact with content in numerous ways, including answering questions, navigating through learning material, selecting options, entering text responses, speaking verbal responses, highlighting portions of text, or requesting assistance. Interaction signals captured through the user interface 104 may be transmitted to the execution unit 108 for analysis.

The interaction signals captured through the user interface 104 may include multiple categories of behavioral indicators associated with user interaction with the presented content. Such interaction signals may include, but are not limited to, response accuracy indicators, response latency indicators, navigation behavior indicators, interaction frequency indicators, and content-selection indicators. In one case, the interaction signals may also include indicators of reading or language comprehension. In another case, the interaction signals may include indicators associated with numerical reasoning or symbolic manipulation. In yet another case, the interaction signals may include indicators associated with recall behavior, pattern recognition, or sequential interaction with instructional material.

The network module 106 enables communication between the various components of the system 100 and external computing environments. The network module 106 may support communication over wired or wireless networks, internet-based communication systems, or cloud computing infrastructure. The network module 106 used for communication support any number of suitable wireless data communication protocols, techniques, or methodologies, including radio frequency (RF), infrared (IrDA), Bluetooth, ZigBee (and other variants of the IEEE 10 802.15 protocol), a wireless fidelity (Wi-Fi) or IEEE 802.11 (any variation), IEEE 802.16 (WiMAX or any other variation), global apparatus for mobile communication (GSM), general packet radio service (GPRS), enhanced data rates for GSM Evolution (EDGE), long term evolution (LTE), cellular protocols (2G, 2.5G, 2.75G, 3G, 4G or 5G), near field communication (NFC), satellite data communication protocols, or any other protocols for wireless communication.

In one example, through the network module 106, the system 100 may retrieve content from the remote content units 102, transmit user interaction data to remote processing servers, or access cloud-based artificial intelligence systems. The network module 106 may also enable communication between distributed system components that are located on different computing devices.

The execution unit 108 performs the system 100's primary computational functions. The execution unit 108 may include hardware processors, memory resources, and software components configured to analyze user interaction signals and produce adaptive responses.

In some examples, the execution unit 108 may include one or more processing modules configured to perform signal analysis, event detection, and response selection operations described herein. The term “processing module”, as used herein, may refer to a software or hardware component executed within the execution unit 108.

In one example, the execution unit 108 may be a computing device or a server.

The execution unit 108 may analyze the interaction signals received from the user interface 104 to identify patterns that may correspond to user-state events. In one case, the analysis may involve evaluating interaction signals across multiple signal channels. For example, response latency indicators and response accuracy indicators may be analyzed together to determine whether the user is experiencing a comprehension difficulty condition. In another case, navigation instability indicators may be evaluated alongside response timing indicators to determine whether the user is experiencing cognitive overload.

The execution unit 108 includes a detection module 108-1, a processing module 108-2, a memory module 108-3, and responsive components 108-4. These modules cooperate to detect user-state events and generate adaptive responses.

The modules of the execution unit 108 may be implemented as software instructions executed by one or more processors, dedicated hardware circuits, programmable logic components, or combinations thereof.

The detection module 108-1 monitors user interactions with the presented content and extracts parameters describing the user's interaction behavior. The detection module 108-1 may include a user parameter acquisition component 108-11 and a context acquisition component 108-12.

The user parameter acquisition component 108-11 may capture various signals generated during interaction with content. These signals may include measures such as response accuracy, response latency, interaction frequency, navigation patterns within the content, input modality usage, and explicit user feedback. These user parameters may be derived from logs of user activity, sensor signals, or interaction telemetry generated by the user interface 104.

The context acquisition component 108-12 may obtain contextual information associated with the user's interaction environment. Examples of contextual information may include difficulty level of presented content, subject or topic context, time of day, session duration, device characteristics, environmental conditions, or user preference indicators. The contextual information may be used to improve the interpretation of user interaction signals and may assist the system 100 in identifying user-state events.

The detection module 108-1 may detect precursor signals indicating a possible future adverse outcome, such as disengagement or comprehension failure, before such outcomes are directly observable.

For instance, when a user repeatedly hesitates among answer choices and exhibits increasing response latencies across a sequence of conceptually related questions, the user parameter acquisition component 108-11 may record these latencies and navigation patterns as user parameters. When combined with contextual information indicating that the current material is labelled as high-difficulty, the detection module 108-1 may interpret this pattern as a precursor signal of cognitive overload, even before the user's accuracy drops.

The interaction signals received from the user interface 104 may be processed to derive behavioral parameters representing measurable characteristics of the user's interaction behavior. Such behavioral parameters may include response latency values, response accuracy indicators, navigation frequency indicators, or other derived interaction metrics.

The processing module 108-2 receives signals from the detection module 108-1 and analyzes the signals to determine whether user-state events have occurred. The processing module 108-2 may include a pre-processing engine 108-21, an event detection unit 108-22, an event classifier unit 108-23, and a response configuration selector 108-24.

The processing module 108-2 may be integrated into the system 100, as shown in FIG. 1. Alternatively, the processing module 108-2 may be located remotely from the system 100. The processing module 108-2 may comprise a single or multi-core processor. The processing module 108-2 executes software instructions or algorithms to implement functional aspects of the present invention. The processing module 108-2 may be a cloud server. The processing module 108-2 may also be implemented as a digital signal processor (DSP), a microcontroller, a designated apparatus on chip (SoC), an integrated circuit implemented with a field programmable gate array (FPGA), an application-specific integrated circuit (ASIC), or a combination thereof. The processing module 108-2 may be implemented using a co-processor for complex computational tasks. The processing module 108-2 utilizes stored logic to execute and control any number of operations simultaneously. The processing module 108-2 may include one or more specialized hardware, software, and/or firmware modules (not shown) specially configured with particular circuitry, instructions, algorithms, or data to perform functions of the disclosed methods. The processing module 108-2 may be a general-purpose computer processor that executes commands or instructions but may utilize any of a wide variety of other technologies, including special-purpose hardware, a microcomputer, mini-computer, mainframe computer, programmed micro-processor, micro-controller, peripheral integrated circuit element, a customer-specific integrated circuit (CSIC), a logic circuit, a programmable logic device (PLD), a programmable logic array (PLA), RFID processor, smart chip, or any other device or arrangement of devices that are capable of implementing the operations of the processes of embodiments of the system 100.

The pre-processing engine 108-21 prepares the captured interaction signals for analysis. The preprocessing operations may include signal normalization, temporal windowing of behavioral data, signal weighting based on contextual importance, baseline adjustments relative to historical user behavior, and extraction of derived features from raw interaction data.

The event detection unit 108-22 analyzes the processed signals to detect patterns that may correspond to user-state events. In some scenarios, algorithmic detection methods may be employed. For example, variability analysis may detect fluctuations in response accuracy, latency analysis may detect delays indicative of cognitive load, and trend detection methods may identify gradual changes in engagement levels. Signal processing techniques such as moving averages, derivative analysis, threshold detection, or machine learning models may be used to identify these patterns.

As used herein, the “user-state event” may refer to a detected condition associated with a user's interaction behavior or cognitive state during interaction with learning content units or the content units 102. The user-state events may include, for example, comprehension difficulty events, cognitive overload events, disengagement events, or other interaction-state conditions detected based on analysis of interaction signals.

Unlike conventional adaptive learning systems that detect performance degradation only after incorrect responses, the detection module 108-1 described herein identifies precursor user-state events indicating potential future interaction failure before observable performance decline. These precursor events are derived from correlated interaction signals, including response latency patterns, navigation behavior, interaction frequency, and contextual parameters. Early detection of such precursor states enables proactive reconfiguration of system 100 responses before observable failure occurs.

The event classifier unit 108-23 may classify detected patterns into one or more defined user-state event types. These event types may include engagement instability, comprehension difficulty, cognitive overload, attentional drift, memory decay, learning instability, or mastery emergence. The user-state event types may comprise at least one of precursor learning states, engagement instability, comprehension difficulty, cognitive overload, attentional drift, memory decay, learning instability, mastery emergence, or other states indicative of changes in user performance, engagement, or learning proficiency. The event classifier unit 108-23 may use probabilistic models, statistical classifiers, rule-based logic, artificial intelligence (AI), or machine learning algorithms to determine the most likely event type. The event classifier unit 108-23 may also assign confidence values indicating the reliability of the classification.

In some cases, the user-state event types may be determined using predefined thresholds, statistical models, machine-learning classifiers, or rule-based evaluation of behavioral parameters derived from interaction signals.

When the event classifier unit 108-23 determines with high confidence that the user is experiencing comprehension difficulty, the response configuration selector 108-24 may increase scaffolding intensity and reduce the content complexity level. The generative instructional component 108-41 may then produce a step-by-step explanation, while the non-generative remedial engine 108-42 simultaneously restructures the content into smaller, sequenced sections and activates vocabulary assistance for key terms.

In some cases, the processing module 108-2 determines response-configuration parameters by applying one or more response-selection policies that map detected user-state event types to corresponding system responses. The response-selection policies may include rule-based mappings, policy tables, probabilistic models, machine-learning models, or hybrid approaches that evaluate detected user-state events, associated confidence values, contextual information, and previously stored user-state representations.

For instance, when the preprocessing engine 108-21 normalizes a user's response latencies over a short temporal window and adjusts them relative to a historical baseline, and the adjusted latencies show a sustained upward trend, the event detection unit 108-22 may detect this as a potential engagement-related pattern. The event classifier unit 108-23 may then classify the pattern as attentional drift with a moderate confidence value, based on the user's prior behavior and current contextual data.

The response configuration selector 108-24 determines system 100 response parameters based on the classified events and stored user-state information. The selector may determine parameters controlling the behavior of responsive components. These parameters may include content modality emphasis, content complexity level, pacing rate, scaffolding intensity, feedback granularity, repetition frequency, and sequencing flexibility. The response configuration selector 108-24 may also determine operational parameters associated with generative models, including prompt conditioning attributes, inference settings, output formatting, and intervention timing.

The “response configuration” may refer to a set of parameters defining how the system 100 responds to a detected user-state event. Such parameters may include instructional modality, content complexity level, pacing adjustments, feedback characteristics, scaffolding level, or presentation format.

In some cases, the response configuration selector 108-24 is configured to determine response-configuration parameters based on the detected user-state events, associated confidence values, and representations stored in the memory module 108-3. The response-configuration parameters may define operational settings for one or more responsive components 108-4.

In contrast to systems that independently detect engagement signals or independently deliver adaptive instructional content, the present system 100 implements an integrated closed-loop architecture in which detected user-state events update persistent state representations that directly influence response-configuration parameters delivered to multiple responsive components. This coordinated architecture enables adaptive interaction strategies that evolve over time based on both historical and current interaction conditions.

The memory module 108-3 stores persistent information describing both the user's state and the system's state. The memory module 108-3 may include a user-state representation store 108-31 and a system-state information store 108-32.

In some examples, the memory module 108-3 stores system-state information representing the system's 100 operational conditions during prior interactions. The system-state information may include records of previously delivered responsive outputs, elapsed time since prior outputs, output frequency, measured effectiveness of prior responses, or user reactions to prior outputs.

The memory module 108-3 may be coupled to the processing module 108-2. The memory module 108-3 may include any of the volatile memory elements (for example, random access memory, such as DRAM, SRAM, SDRAM, etc.), non-volatile memory elements (for example, ROM, hard drive, etc.), magnetic, semiconductor, tape, optical, removable, non-removable, or other types of storage device or tangible and combinations thereof. Typical forms of non-transitory media include, for example, a flash drive, a flexible disk, a hard disk, a solid state drive, magnetic tape or other magnetic data storage medium, a CD-ROM or other optical data storage medium, any physical medium with patterns of holes, a non-transitory computer-readable medium, RAM, a PROM, and EPROM, a FLASH-EPROM, other flash memory, NVRAM, a cache, a register, other memory chip or cartridge, or networked versions of the same. The memory module 108-3 may have a distributed architecture, where various components are situated remotely from one another but can be accessed by the processing module 108-2. Alternatively, the memory module 108-3 may be placed locally or remotely, depending on the type of processing module 108-2. The memory module 108-3 may include one or more software programs, or algorithms, each of which includes an ordered listing of executable instructions for implementing logical functions.

The user-state representation store 108-31 may contain representations of the user's evolving learning state. These representations may include cognitive state indicators, mastery progression data, engagement stability measures, user preferences, predicted learning outcomes, performance history data, and references to previously detected events.

The system-state information store 108-32 may track historical responses from the system 100 and interaction outcomes. Examples of stored system-state information may include previously delivered outputs, elapsed time since prior interventions, intervention frequency, effectiveness of past responses, and user reactions to prior outputs.

Information stored in the memory module 108-3 may be used to update detection sensitivity or threshold parameters, enabling the system 100 to learn from past interactions and improve detection accuracy.

In some examples, the system 100 may further store records of previously applied instructional transformations, including restructuring, summarization, segmentation, accessibility adjustments, or presentation modifications.

Transformations that improve user stability may be marked as preferred and reused when similar user-state events are detected.

The responsive components 108-4 generate adaptive responses that are presented to the user through the user interface 104. In the illustrated example, the responsive components include a generative instructional component 108-41, a non-generative remedial engine 108-42, and a coordination interface 108-43.

In some examples, the processing module 108-2 coordinates delivery of response-configuration parameters to multiple responsive components 108-4, including both generative instructional components and non-generative remedial or accessibility intervention engines. The coordination may include determining whether responses are delivered sequentially, concurrently, or conditionally based on the detected user-state events and stored system-state information.

The generative instructional component 108-41 may generate instructional responses dynamically using generative artificial intelligence models. The generated responses may include explanations of concepts, step-by-step problem-solving guidance, examples or analogies, hints, or clarifications. The parameters governing the generation of these responses may be adjusted by the response configuration selector 108-24.

In some cases, the generative instructional component 108-41 may include one or more machine-learning models configured to generate instructional explanations, feedback, or guidance in response to received response-configuration parameters.

In some scenarios, the response configuration parameters may be organized into response-configuration parameter spaces representing possible instructional response behaviors. Subsets of these parameters may form response-configuration parameter subspaces associated with particular detected user-state events.

The response-configuration parameter subspace may constrain parameter values, including content complexity, pacing, scaffolding intensity, feedback timing, repetition frequency, and instructional sequencing.

The system 100 may select parameter combinations from these subspaces based on the historical effectiveness of responses applied to similar user-state events.

The non-generative remedial engine 108-42 may provide accessibility or remediation interventions. Such interventions may include text-to-speech rendering, captioning, visual text extraction, extended-time adjustments, vocabulary assistance, translation, highlighting, annotation tools, summaries, or content restructuring. The non-generative remedial engine 108-42 may also provide attention-regulation tools such as interface simplification, screen masking, visual tinting, progressive disclosure of information, or content segmentation.

The coordination interface 108-43 may coordinate responses generated by the generative instructional component 108-41 and the non-generative remedial engine 108-42. The coordination interface 108-43 may determine whether interventions should be escalated, maintained, or reduced based on updated user-state representations 108-31.

In some examples, the system 100 may evaluate the effectiveness of applied interventions by monitoring subsequent user performance stability, changes in engagement, trends in response latency, and user-state transitions.

Intervention outcomes may be stored within the memory module 108-3 and incorporated into the dynamic user profile to guide future intervention selection.

The system 100 may prioritize interventions that historically improved stability for similar user-state conditions.

When the event classifier unit 108-23 determines that the user is experiencing comprehension difficulty with a high confidence value, the response configuration selector 108-24 may increase scaffolding intensity and reduce content complexity level. The generative instructional component 108-41 may then generate a step-by-step explanation, while the non-generative remedial engine 108-42 simultaneously restructures the content into smaller, sequenced sections and activates vocabulary assistance for key terms. Later, if user state representations indicate that the user is responding confidently and completing tasks with shorter latency, the coordination interface 108-43 may reduce the intensity of both generative and non-generative interventions, present only minimal hints and basic accessibility features, while allowing the user to proceed with more complex material.

The system 100 may be implemented using various architectural configurations, including integrated, distributed, and hybrid architectures. Each configuration supports different deployment scenarios, such as single-device applications, large-scale cloud-based services, or mixed environments where some components run locally, and others operate remotely.

The detection techniques, user modeling techniques, intervention strategies, predictive techniques, and content adaptation mechanisms described herein may be combined in various configurations.

Features described in connection with one embodiment may be applied to other embodiments without limitation.

Modifications and variations may be made without departing from the scope of the present invention.

In an integrated architecture, the content units 102, the user interface 104, and the execution unit 106 may operate within a single computing device such as a personal computer, tablet, or specialized learning device. All components, including the detection module 106-1, the processing module 106-2, and the memory module 106-3, may be hosted on the same device (as shown in FIG. 1(B), resulting in a self-contained system with minimal reliance on external networks. This configuration is suitable for offline or low-connectivity environments and simplifies deployment when the system is used by a single user or a small group of users on dedicated hardware.

In a distributed architecture, different components of system 100 may operate on different computing systems. For example, the user interface 104 may operate on a client device, such as a laptop, mobile phone, or classroom terminal, while the execution unit 108 may operate on a remote server, and the memory module 108-3 may be implemented using cloud storage infrastructure. Communication between components is coordinated through the network module 106, which may route user interaction data to remote processing nodes and deliver generated adaptive responses back to the client device. This configuration enables centralized resource management, efficient updates to the detection and processing logic, and scalability across many concurrent users.

A hybrid architecture may combine local and remote processing to balance responsiveness and computational capacity. For example, detection operations, such as basic parameter acquisition and lightweight event detection, may occur locally on the user's device to reduce latency and conserve network bandwidth, while more computationally intensive processing operations, such as machine learning inference, model-based event classification, and long-term user-state representation updates, may be executed on remote servers or cloud computing platforms. The system 100 may dynamically decide which tasks to offload based on device capabilities, network conditions, and privacy or security constraints, while still ensuring that time-sensitive interventions are delivered with low end-to-end delay.

These architectural configurations allow the system 100 to support a large number of users while maintaining responsive interaction performance. The integrated architecture is well-suited for constrained or standalone environments, the distributed architecture simplifies centralized management and scaling, and the hybrid architecture offers a flexible trade-off between local responsiveness and remote computational power, enabling the system 100 to adapt to diverse deployment settings and user-facing devices.

During operation, the content from the content units 102 is delivered to the user interface 104 and presented to the user. As the user interacts with the presented content, interaction signals are captured by the user interface 104 and transmitted to the detection module 108-1.

The user parameter acquisition component 108-11 extracts behavioral parameters from the interaction signals, while the context acquisition component 108-12 obtains contextual information related to the interaction. These signals are then transmitted to the processing module 108-2.

The pre-processing engine 108-21 prepares the signals for analysis, and the event detection unit 108-22 analyzes the signals to detect patterns indicative of potential user-state events. The detected signals are classified by the event classifier unit 108-23, which determines the type of user-state event and assigns confidence values.

In some examples, the processing module 108-2 dynamically adjusts detection sensitivity parameters, event classification thresholds, or feature weighting values based on historical user interactions and observed outcomes following prior responsive outputs.

The detected events and associated contextual information are stored in the memory module 108-3. Based on this information, the response configuration selector 108-24 determines configuration parameters controlling the responsive components 108-4.

The responsive components 108-4 then generate adaptive outputs that are delivered to the user through the user interface 104. The resulting user interactions generate new signals that are again analyzed by the system 100, thereby completing the closed feedback loop.

### Exemplary Scenarios

In one scenario, the system 100 detects signals indicating cognitive overload while the user interacts with complex instructional material. The user interface 104 presents a dense sequence of concepts, such as multi-step mathematical explanations embedded with symbolic expressions and graphs. The system 100 observes that the user's response latencies are increasing, the user repeatedly revisits earlier sections, and the number of “confused” or “help” signals rises, all of which occur before the user's accuracy sharply declines. The system 100 interprets this pattern as an early sign of cognitive overload and responds by generating simplified, stepwise explanations and by presenting a condensed summary of the core ideas. At the same time, the user interface 104 may restructure the content into smaller, clearly labeled segments, highlight key relationships, and optionally offer text-to-speech or captions to reduce the information-processing burden on the user. As the user's responses become more confident and latency decreases, the system 100 gradually restores more complex material and reduces the level of explicit support.

In another scenario, the system 100 detects comprehension difficulty based on repeated incorrect or highly uncertain responses. The user works through a series of practice questions that build on a new topic, yet the same type of error recurs across several items, and the user often skips ahead or rewinds without clear improvement. The system recognizes this as a persistent comprehension difficulty rather than simple slips and increases instructional scaffolding. It delivers step-by-step breakdowns of each problem, breaking complex tasks into smaller sub-steps and providing intermediate prompts that guide the user toward the correct reasoning path. The content is reorganized into a more hierarchical layout with clear labels for each conceptual step, and optional vocabulary assistance or annotations appear for foundational terms associated with the errors. As the user starts to answer intermediate checks correctly and pauses become more focused rather than frantic, the system 100 interprets this as improving comprehension and begins to phase out detailed scaffolding while maintaining just enough support to consolidate learning.

In another scenario, the system 100 detects attention drift during a long session with multimedia content. The user interface 104 initially displays a continuous article with embedded videos and interactive questions, but the user's interaction becomes irregular: long stretches of inactivity alternate with rapid scrolling, skipped sections, and frequent switching between input modes. The system 100 interprets these patterns as attentional drift and activates attention-regulation tools. The user interface 104 is simplified by hiding non-essential sidebars, advertisements, or secondary widgets that compete for focus. Sections of the content are progressively disclosed, revealing only one manageable segment at a time, and the visual layout is “masked” to reduce clutter. For example, by dimming background elements or applying a soft visual tint over inactive areas. The system 100 may also introduce brief, interactive checkpoints or short reflective prompts to re-engage the user. As the interaction pattern becomes more consistent and the user progresses through each disclosed segment without skipping, the system 100 reduces the intensity of these interventions while maintaining a clean, distraction-resistant layout.

In yet another scenario, the system 100 detects mastery when the user consistently performs at a high level on a given topic. The user completes a series of practice items and application tasks with high accuracy and short response times, rarely needing hints or revisiting earlier explanations. The system 100 interprets this pattern as stable mastery or mastery emergence and adapts the interaction accordingly. The content complexity is increased, for example, by presenting more advanced problems, multi-step reasoning tasks, or transfer questions that connect the mastered concept to new domains. Instructional scaffolding is reduced so that prompts become more open-ended and fewer intermediate steps are provided, encouraging the user to generate solutions more independently. At the same time, the system may offer optional enrichment material, such as a deeper theoretical background or extensions on related topics, to keep the user engaged without reintroducing unnecessary scaffolding. As the user continues to succeed at this higher level, the system 100 treats the topic as consolidated and shifts focus toward more challenging or novel content while preserving light accessibility features, such as optional summaries or captions, for future reference.

The described system 100 enables efficient processing of interaction signals and real-time reconfiguration of dynamic systems, thereby improving the performance of interactive computing platforms that deliver instructional or informational content.

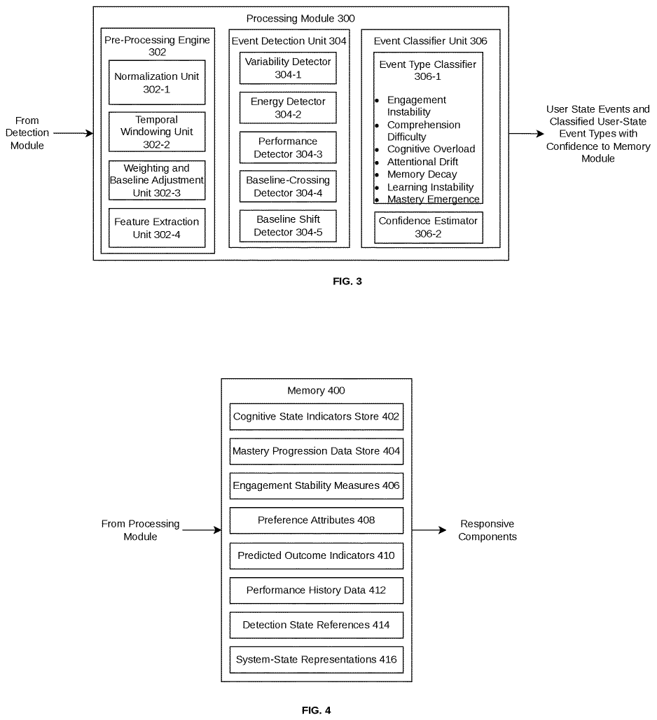

FIG. 2 illustrates an architecture 200 for capturing and organizing user interaction and content metadata in accordance with an exemplary embodiment of the present invention. The architecture 200 is used by the processing module (as explained in detail in FIGS. 1 and 3) to determine user-state events and corresponding user-state event types.

The architecture 200 includes a detection module 202 and a content module 204, which together provide complementary streams of user interaction signals and content-related contextual metadata to the processing module.

The detection module 202 aggregates observable interaction signals emitted during a user's engagement with content delivered via the user interface from one or more content units. For example, when a user interacts with a sequence of practice questions in an educational application, the detection module 202 records correctness, timing, and navigation behavior for each interaction in real time. In other examples, the detection module 202 may additionally ingest sensor-derived signals, such as eye-tracking stability, pointer movement patterns, or device orientation, provided such signals are available and consented to by the user or supervising entity.

The detection module 202 includes an accuracy and outcome tracker 202-1, a latency and timing monitor 202-2, an interaction frequency and rhythm monitor 202-3, a navigation behavior tracker 202-4, an input modality logger 202-5, and an explicit feedback capture unit 202-6.

The accuracy and outcome tracker 202-1 monitors the correctness or success of user responses or actions relative to the presented content. In one example, the accuracy and outcome tracker 202-1 records whether each quiz question is answered correctly, whether a hint was requested, or whether a task was abandoned before completion. As an alternative example, in a productivity or training application, the accuracy and outcome tracker 202-1 may record the completion status of tasks, the number of errors per task, or pass/fail outcomes for embedded assessments.

The latency and timing monitor 202-2 captures temporal characteristics of user interaction. For instance, the latency and timing monitor 202-2 may measure response latency between the display of a question and the submission of an answer, dwell time on individual content items, or idle periods between successive interactions. In other examples, the latency and timing monitor 202-2 may track session start and end times, micro-break frequencies, or patterns of rapid guessing, which may serve as indicators of cognitive overload or disengagement.

The interaction frequency and rhythm monitor 202-3 records the rate and pattern of interaction events over time. In a representative scenario, the interaction frequency and rhythm monitor 202-3 tracks how many interactions (example, clicks, key presses, question responses) occur per minute and whether the interaction pace is steady, gradually slowing, or highly variable. In alternative implementations, the interaction frequency and rhythm monitor 202-3 may detect bursts of interaction followed by extended pauses, which may be associated with attentional drift or emerging frustration.

The navigation behavior tracker 202-4 is configured to log how the user traverses within and across content units. For example, the navigation behavior tracker 202-4 may record scrolling patterns, backward jumps to earlier sections, repeated replays of a video segment, or skipping of recommended content. In other examples, the navigation behavior tracker 202-4 may track out-of-order progression, rapid tab switching between topics, or frequent transitions between summary and detailed views, which may signify comprehension difficulty or information-seeking strategies.

The input modality logger 202-5 records the modalities through which the user provides input to the system. For instance, the input modality logger 202-5 may track whether the user responds using keyboard text input, speech input, selection from multiple-choice options, touch gestures, pen input, or assistive devices. In some implementations, shifts in input modality, such as switching from typed responses to multiple-choice selections or speech input, may be correlated with fatigue, motor difficulty, or preference for a particular interaction channel.

The explicit feedback capture unit 202-6 is configured to gather user-provided feedback signals. In one example, the explicit feedback capture unit 202-6 receives ratings of difficulty (example, “too easy”, “just right”, “too hard”), self-reported confidence levels, or qualitative comments entered through the user interface. In other examples, the explicit feedback capture unit 202-6 may capture reactive signals such as “thumbs up” or “thumbs down” on an explanation, requests for more examples, or explicit help-seeking actions, which are used as labeled indicators for certain user-state event types.

Complementing the detection module 202, the content module 204 provides content-related metadata that characterizes the material being presented and the context in which it is consumed. The content module 204 may ingest metadata directly from the content units, a learning management system, an authoring pipeline, or external context providers such as calendaring and device APIs. By combining content metadata with user interaction signals, the processing module may disambiguate whether observed patterns are likely attributable to user-specific state changes, content characteristics, or environmental conditions.

The content module 204 includes a content difficulty metadata component 204-1, a topic and curriculum context component 204-2, a time-of-day and session duration component 204-3, a device and environment characteristics component 204-4, and user preference indicators 204-5.

The content difficulty metadata component 204-1 encodes the difficulty information for each content item. For example, the content difficulty metadata 204-1 may include estimated reading level, problem difficulty ratings, prerequisite dependencies, or normative item response theory parameters such as discrimination and difficulty indices. In alternative scenarios, the content difficulty metadata 204-1 may dynamically evolve based on aggregated performance data across users, such that a question's effective difficulty is updated as new interaction data becomes available.

The topic and curriculum context component 204-2, which specifies the conceptual domain and curricular structure associated with the content. For instance, the topic and curriculum context 204-2 may indicate that a problem belongs to “algebra, linear equations, grade 8”, or that a passage pertains to “world history, World War II, advanced level”. In some implementations, the topic and curriculum context 204-2 may further encode the user's current learning path, alignment with standards, or relationships to prior and subsequent learning objectives, allowing the processing module to infer mastery progression and knowledge gaps more precisely.

The time-of-day and session-duration component 204-3 captures the temporal context of content delivery and user interaction. In one example, the time-of-day and session duration component 204-3 records that a given interaction occurs late at night after a long session, which may increase the likelihood of fatigue-related events such as attentional drift or cognitive overload. In other examples, the time-of-day and session duration component 204-3 may track cumulative active time in the current session, the number of sessions completed within a day, or the spacing between sessions to inform the detection of memory decay or spacing effects.

The device and environment characteristics component 204-4 that reflects properties of the user's device and surrounding environment. For example, the device and environment characteristics 204-4 may specify whether the user is interacting on a mobile phone, tablet, laptop, or large display, as well as screen size, available input devices, and network conditions. In some implementations, environment characteristics may incorporate coarse context, such as “home,” “school,” or “public space,” when available, or reflect ambient noise-level categories derived from on-device sensors. Thereby helping distinguish environment-induced disruptions from intrinsic attentional issues.

The user preference indicators component 204-5 captures persistent or dynamic preferences expressed or inferred for a given user. For instance, the user preference indicators 204-5 may encode preferred modality (example, text-first, audio-first, or mixed), reading speed, language choices, font size or theme preferences, or previously selected accessibility options. In alternative examples, the user preference indicators 204-5 may be inferred from historical behavior, such as consistent selection of “more detailed explanations”, repeated enabling of captioning, or frequent use of translation tools, and used to condition subsequent responsive outputs.

In some examples, user preference indicators may also serve as response-control parameters that influence instructional pacing, explanation depth, modality selection, scaffolding intensity, and interaction complexity.

The system 100 may dynamically reconcile detected user-state events with stored user preferences to determine optimal response configurations.

During operation, the detection module 202 and the content module 204 jointly output user interaction signals and content/context metadata as “user interaction and content metadata” to the processing module. In one implementation, these outputs are streamed continuously, enabling near real-time inference of user-state events such as engagement instability, comprehension difficulty, or cognitive overload. In other implementations, the outputs of the detection module 202 and the content module 204 may be buffered and processed in mini-batches. For example, at the end of each problem set, video segment, or reading section, thereby reducing computational load while still enabling timely adaptation.

In some examples, additional or alternative submodules may be included within the detection module 202 or the content module 204 to address specific domains or interaction modes. For example, a biometric signal tracker may be added to the detection module 202 to monitor heart rate variability or galvanic skin response for users interacting through compatible wearable devices. As another example, the content module 204 may be extended with a social or collaborative context component that encodes whether the user is working individually, in pairs, or in a group setting, enabling different interpretations of pauses, turn-taking, or shared navigation behaviors.

Although FIG. 2 depicts the detection module 202 and the content module 204 as logically distinct components, in other implementations, their functions may be integrated into a single instrumentation layer or distributed across multiple microservices. For example, a cloud-based analytics service may implement the detection module 202, while an on-device content player provides metadata for the content module 204, or vice versa. Similarly, certain features may be computed at the edge, such as instantaneous interaction frequency, while aggregated statistics and higher-level indicators are computed centrally within the processing module.

In this way, the architecture 200 illustrates how user interaction signals and content/context metadata are systematically captured, structured, and made available to downstream components to support the detection of user-state events, the classification of user-state event types, and the subsequent adaptation of generative and non-generative responsive components, as described elsewhere in this specification.

In some cases, the architecture 200 illustrated in FIG. 2 represents a functional decomposition of components described with respect to FIG. 1. For example, the detection module 202 may correspond to the detection module of FIG. 1, and the content module 204 may cooperate with the user interface and the network module to facilitate acquisition and delivery of content units. Similarly, subsequent modules are described with respect to FIGS. 3-7 may represent functional subdivisions of the execution unit 108 introduced in FIG. 1.

FIG. 3 illustrates a processing module 300 in accordance with an exemplary embodiment of the present invention. The processing module 300 receives user interaction and content metadata from the detection module and content module (as discussed in detail in FIG. 2), identifies user-state events, classifies the user-state events into one or more user-state event types, and outputs user-state events and classified user-state event types with associated confidence values to a memory module. In the depicted scenario, the processing module 300 includes a pre-processing engine 302, an event detection unit 304, and an event classifier unit 306, which may be implemented as software components executing on one or more processors, as dedicated hardware logic, or as a combination thereof.

The pre-processing engine 302 prepares raw user parameters and contextual signals for downstream detection and classification. In some implementations, the pre-processing engine 302 receives, as input, measurements such as question-level accuracy, response latencies, interaction frequencies, navigation patterns, input modalities, explicit feedback indicators, and content/context metadata as described with respect to FIG. 2. The pre-processing engine 302 operates continuously or in discrete time windows, enabling both real-time responsiveness and retrospective analysis of user behavior over longer intervals.

The pre-processing engine 302 includes a normalization unit 302-1, a temporal windowing unit 302-2, a weighting and baseline adjustment unit 302-3, and a feature extraction unit 302-4.

The normalization unit 302-1 is configured to normalize heterogeneous input signals into a common representation space. In one embodiment, this common representation space is a multi-dimensional, temporally indexed feature space in which normalized signals are positioned relative to baseline reference regions corresponding to expected learner performance and interaction behavior. For example, the normalization unit 302-1 may convert raw response times into z-scores relative to a user-specific or population baseline, transform accuracy into rolling proportions over a fixed number of recent items, or scale navigation counts into rates per minute. These normalized values may be mapped within the representation space so that deviations from baseline correspond to spatial displacements along one or more dimensions (e.g., performance, engagement, or temporal stability).

In alternative scenarios, the normalization unit 302-1 may perform per-user, per-content, or per-cohort normalization so that signal values are positioned relative to context-specific reference regions within the representation space. In this manner, deviations are interpreted as spatial offsets from appropriate baseline regions rather than absolute values, thereby improving robustness and consistency of downstream event detection across heterogeneous learners, content types, and learning conditions.

In some implementations, event detection algorithms may include variability detectors, oscillatory behavior detectors, baseline drift detectors, engagement momentum detectors, and sequence pattern detectors configured to identify evolving user-state conditions.

A temporal windowing unit 302-2 segments the normalized signals into temporal windows for analysis. In one example, the temporal windowing unit 302-2 may generate overlapping windows spanning the last N interactions (example, the last 10 questions) or the last T seconds or minutes of activity, enabling detection of emerging trends rather than isolated outliers. In other implementations, the temporal windowing unit 302-2 adapts the window size based on session length, content structure (example, per problem set or video segment), or event density, such that finer-grained windows are used during periods of rapid change and coarser windows during stable periods.

The weighting and baseline adjustment unit 302-3 adjusts the influence of different signals and accounts for evolving baselines. For instance, the weighting and baseline adjustment unit 302-3 may assign higher weights to recent interactions, specific high-stakes tasks, or explicit feedback signals when aggregating evidence for an event, while down-weighting noisy or less informative signals. In some examples, the weighting and baseline adjustment unit 302-3 updates a user-specific baseline for measures such as speed or accuracy over time, so that gradual learning gains or device changes do not falsely trigger event detection.

The feature extraction unit 302-4 derives higher-level features from the pre-processed signals for use by the event detection unit 304 and event classifier unit 306. For example, the feature extraction unit 302-4 computes moving averages and variances of response times, error-streak lengths, success-after-hint patterns, the frequency of backward navigation, or the rates of help and summary requests. In alternative scenarios, the feature extraction unit 302-4 generates composite indicators such as “engagement stability index,” “cognitive load proxy,” or “navigation irregularity score” using rule-based combinations, statistical models, or learned feature embeddings.

The event detection unit 304 receives the extracted features and determines whether one or more user-state events are present within a given analysis window. In some implementations, the event detection unit 304 outputs event candidates annotated with timestamps, feature values, and preliminary scores, which are then interpreted further by the event classifier unit 306. The event detection unit 304 may apply threshold-based logic, statistical change detection, machine learning models, or hybrid approaches to determine when a significant deviation from baseline or expected behavior has occurred.

The event detection unit 304 includes a variability detector 304-1, an energy detector 304-2, a performance detector 304-3, a baseline-crossing detector 304-4, and a baseline shift detector 304-5.

The variability detector 304-1 identifies increased variability in user performance or interaction patterns. For example, the variability detector 304-1 may signal a potential event when response times alternate between very short and very long values, or when accuracy fluctuates sharply across a small number of items. Such variability may indicate engagement instability, momentary distractions, or mixed comprehension, and is therefore forwarded as evidence of one or more user-state event types.

The energy detector 304-2 detects changes in overall interaction “energy”, such as sustained high-frequency interactions or pronounced slowdowns. In one scenario, the energy detector 304-2 flags potential cognitive overload when interaction frequency remains high, but accuracy drops or identifies possible attentional drift when both interaction frequency and responsiveness decline. In alternative implementations, the energy detector 304-2 may integrate additional signals, such as scrolling velocity, gesture intensity, or micro-pauses, into its responses to more finely characterize user effort and arousal.

The performance detector 304-3 monitors performance-signals such as accuracy, partial credit, hints used, and error types. For example, the performance detector 304-3 may detect a streak of incorrect responses on items of a similar topic and difficulty, suggesting comprehension difficulty or an underlying misconception. In some scenarios, the performance detector 304-3 may also distinguish between careless mistakes (example, rapid, low-latency incorrect responses) and deep misunderstanding (example, careful but consistently incorrect attempts), thereby providing richer input to the event classifier.

The baseline-crossing detector 304-4 identifies when a metric crosses a predefined or learned threshold relative to baseline. As one example, baseline-crossing detector 304-4 may trigger an event when response latency exceeds a certain multiple of the user's typical latency or when accuracy falls below a minimum acceptable rate for a given difficulty level. In other implementations, the baseline-crossing detector 304-4 may track cumulative measures, such as total unanswered questions or cumulative time without a correct response, and signal events when those measures exceed configured limits.

The baseline shift detector 304-5 identifies more gradual, sustained shifts in user behavior over longer periods. For instance, the baseline shift detector 304-5 may determine that a user's typical accuracy for a topic has permanently increased, consistent with the emergence of mastery, or has decreased, suggesting learning instability or forgetting. In some scenarios, the baseline shift detector 304-5 supports adaptive recalibration of the underlying baselines used by the normalization unit 302-1 and the weighting and baseline adjustment unit 302-3, thereby maintaining sensitivity without excessive false positives.

The event classifier unit 306 receives event candidates and associated features from the event detection unit 304 and assigns one or more user-state event types with corresponding confidence values. In some implementations, the event classifier unit 306 may be implemented using rule-based logic, probabilistic models, discriminative classifiers, neural networks, or a combination of these, and trained or configured to map feature patterns and detected conditions to semantic event types. The event classifier unit 306 may output single-label events, multi-label events, or hierarchical event labels depending on configuration.

The event classifier unit 306 includes an event type classifier 306-1 and a confidence estimator 306-2. The event type classifier 306-1 distinguishes among multiple user-state event types, such as engagement instability, comprehension difficulty, cognitive overload, attentional drift, memory decay, learning instability, and mastery emergence. For example, if the input features show declining interaction energy, increased variability in navigation, and reduced response frequency without an immediate drop in accuracy, the event type classifier 306-1 may infer attentional drift with moderate confidence. Alternatively, if performance detector 304-3 reports repeated incorrect responses on conceptually related items at a high level of difficulty, combined with explicit reports of “too hard,” the event type classifier 306-1 may classify the event as comprehension difficulty or cognitive overload with high confidence.

The confidence estimator 306-2 determines confidence values associated with each assigned user-state event type. In one example, the confidence estimator 306-2 computes a numerical confidence score based on classifier probabilities, agreement among multiple detection signals, or consistency over successive time windows. In other scenarios, the confidence estimator 306-2 may output discrete confidence bands (example, low, medium, high) or incorporate uncertainty estimates derived from Bayesian models or ensemble variance, which may influence how aggressively responsive components adapt their behavior.

The outputs of the event classifier unit 306, including the identified user-state events, corresponding user-state event types, and associated confidence values, are provided to a memory module (as shown in FIG. 4) for persistent storage and aggregation. In some implementations, these outputs are also fed back into the processing module 300 as part of system-state information, enabling the detection thresholds, baselines, or classifier parameters to be updated over time based on historical user responses and outcomes. In alternative architectures, the event classifier unit 306 may also directly signal certain high-severity events, such as imminent disengagement or pronounced cognitive overload, to responsive components for immediate intervention, while still logging the events in the memory module for longer-term modeling.

Although FIG. 3 depicts the pre-processing engine 302, the event detection unit 304, and the event classifier unit 306 as distinct logical components. In other scenarios, their functions may be combined, rearranged, or distributed across multiple services or devices. For instance, lightweight pre-processing and detection logic may be executed on a client device, while more computationally intensive classification models run on a server, or an integrated model may jointly learn feature extraction, event detection, and event classification in an end-to-end fashion. In all such cases, the processing module 300 operates to transform raw interaction and context signals into semantically meaningful user-state events that may drive the adaptive, state-responsive behavior of both generative and non-generative components, as described elsewhere herein.

FIG. 4 illustrates a memory module 400 in accordance with an exemplary embodiment of the present invention. The memory module 400 persistently stores and updates representations of the user's state and associated system-state information for use by responsive components. The memory module 400 includes a cognitive state indicators store 402, a mastery progression data store 404, engagement stability measures 406, preference attributes 408, predicted outcome indicators 410, performance history data 412, detection state references 414, and system-state representations 416, each of which may be implemented as one or more logical data structures in local or distributed storage.

The memory module 400 may store historical interaction data associated with prior interactions between the user and the system. Such stored data may include detected user-state events, associated interaction-signal features, timestamps, and response actions generated by the system. The stored interaction history may be accessed by the execution unit to support subsequent detection and adaptation processes.

In one example, the memory module 400 may maintain a user profile that includes stored interaction history and derived performance indicators associated with prior interactions between the user and the system.

In operation, the memory module 400 receives user-state events and classified user-state event types with associated confidence values from the processing module 300, and updates corresponding records in one or more of its constituent stores. In some implementations, the memory module 400 maintains both current (or “working”) representations that summarize recent behavior and longer-term historical records that capture trends across sessions. The responsive components, including generative instructional and non-generative remedial engines, may query memory module 400 for push updates or receive them to adapt interaction policies in a state-aware manner.

The cognitive state indicators store 402 maintain representations of inferred cognitive and affective states of the user. For example, the cognitive state indicators 402 may record recent levels or probabilities of engagement instability, comprehension difficulty, cognitive overload, attentional drift, memory decay, learning instability, or mastery emergence as determined by the event classifier unit 306. In alternative examples, the cognitive state indicators 402 may also encode composite indices, such as an overall cognitive load score or a concentration index, derived from multiple event types and detection signals.

The mastery progression data store 404 tracks the user's evolving mastery of concepts, skills, or curricular objectives. In one example, the mastery progression 404 may store, for each skill or learning objective, an estimated mastery level, a confidence interval, timestamps of key transitions (example, from “emerging” to “proficient”), and supporting evidence, such as sequences of correct and incorrect responses. In other implementations, the mastery progression data store 404 may incorporate representations derived from knowledge-tracing models, item response theory, or competency graphs, thereby enabling responsive components to select appropriately challenging content or trigger reinforcement when mastery decay is suspected.

The engagement stability measures 406 capture metrics and summaries related to the stability of the user's engagement over time. For instance, engagement stability measures 406 may maintain rolling statistics on interaction frequency, variance in response latency, frequency of help requests, or the occurrence rate of engagement-related events, such as attentional drift or disengagement precursors. In some scenarios, the engagement stability measures 406 are used to determine whether to escalate, maintain, or de-escalate the intensity of interventions, such as attention-regulation tools or motivational prompts, based on how stable or fragile the user's engagement appears.

The preference attributes store 408 maintains persistent or slowly varying preference information for the user. As an example, the preference attributes 408 may record preferred modality emphasis (for example, text-heavy versus visual explanations), typical explanation depth, preferred language and reading level, accessibility feature usage (such as consistent reliance on captions or text-to-speech), and style preferences for feedback or encouragement. In alternative scenarios, the preference attributes 408 may be derived from both explicit user-selected settings and implicit behavioral signals, such as repeated selection of certain explanation formats, and may be used to condition both generative outputs and non-generative interventions.

The predicted outcome indicators 410 store predictions about future performance, engagement, or risk states given current and historical data. For example, the predicted outcome indicators 410 may include estimates of the likelihood that the user will correctly answer the next item in a given topic, the probability of session dropout in the next few minutes, or the risk of impending cognitive overload if current pacing continues. In some implementations, the predicted outcome indicators 410 are generated by predictive models that ingest the cognitive state indicators store 402, the mastery progression data store 404, engagement stability measures 406, and performance history data 412, and are used to proactively trigger adaptations before adverse outcomes manifest.

The performance history data 412 maintains detailed historical records of the user's interactions and outcomes. In one example, the performance history data 412 may log per-item or per-activity records, including at timestamps, content identifiers, difficulty metadata, user responses, correctness, latency, hints used, navigation behavior, and associated inferred states, or historical user states at the time of interaction. In alternative examples, the performance history data 412 may be aggregated into higher-level summaries such as per-topic accuracy curves, distribution of response times, or counts of prior interventions and their observed effects, enabling both longitudinal analysis and model retraining.

The detection state references 414 store information about the internal state of detection and classification processes. For example, the detection state references 414 may include current detector thresholds, adaptive baselines, sliding-window statistics, or model version identifiers that the processing module uses when generating events. In some examples, the detection state references 414 allow the system to reconstruct why a particular event was generated (for example, which thresholds were crossed), facilitate debugging or auditability, and support meta-adaptation, in which detection sensitivity is updated based on user responses to prior interventions.

The system-state representations 416 maintain information about the overall responsive system's state, particularly regarding previously delivered responsive outputs. As an example, the system-state representations 416 may record which generative instructional responses, summaries, restructurings, or remedial interventions were delivered, when, and with what parameter settings (such as explanation depth or pacing). In other implementations, the system-state representations 416 may also track elapsed time since the last intervention, cumulative intervention intensity within a session, user reactions (for example, whether an explanation was marked helpful), historical system-states and inferred effectiveness of prior actions, thereby enabling feedback loops in which future adaptations depend on past system behavior.

The memory module 400 communicates with responsive components to provide updated representations of user state and system state. In some implementations, generative instructional components subscribe to changes in the cognitive state indicators 402 and the mastery progression 404 to adjust explanation depth, scaffolding level, or content selection, while non-generative remedial engines consult the engagement stability measures 406, the preference attributes 408, and the system-state representations 416 to decide which accessibility or attention-regulation tools to activate. In alternative architectures, the memory module 400 may expose an API through which external analytic services or instructor dashboards may query aggregated indicators, subject to privacy and access control policies.

Although FIG. 4 depicts the cognitive state indicators store 402, the mastery progression data store 404, the engagement stability measures 406, the preference attributes 408, the predicted outcome indicators 410, the performance history 412, the detection state references 414, and the system-state representations 416 as distinct logical stores. In other examples, some or all of these stores may be combined, partitioned, or implemented using different underlying technologies. For example, short-term, high-frequency data (such as recent events and sliding-window statistics) may be maintained in a fast in-memory store, while long-term historical data and model parameters persisted in a slower archival datastore, and certain privacy-sensitive attributes may be encrypted or stored on-device rather than in a cloud service. Regardless of the specific implementation, the memory module 400 maintains a rich, temporally aware representation of both user and system state that the rest of the system may leverage for responsive, state-driven adaptation.

FIG. 5 illustrates a generative instructional component control architecture 500 in accordance with an exemplary embodiment of the present invention. The generative instructional component control architecture 500 includes a generative instructional component 502 and a generative control interface 504. The generative instructional component 502 is based on user-state representations and system-state information maintained in the memory module. The generative control interface 504, which comprises a parameter selector 504-1 and an inference-control parameter set 504-2 that collectively determine how the generative instructional component 502 produces responsive outputs delivered to the user interface.

The generative instructional component 502 includes one or more generative models, such as large language models, multi-modal generative models, or domain-specific instructional generators, configured to produce explanations, hints, summaries, examples, practice questions, or other pedagogical content. In some implementations, the generative instructional component 502 operates as a service that receives a prompt or request, along with an associated set of control parameters, and returns a candidate response, which is then displayed or otherwise communicated to the user. In an alternative implementation, the generative instructional component 502 may be integrated directly with the user interface to support interactive dialogues, adaptive tutoring conversations, or step-by-step solution guidance.

The generative control interface 504 mediates between the memory module and the generative instructional component 502. In one example, the generative control interface 504 receives updated representations of user state, such as cognitive state indicators, mastery progression levels, engagement stability measures, and preference attributes, as well as system-state representations describing recent interventions and their outcomes. The generative control interface 504 then determines a set of inference-control parameters that specify how the generative component should respond in the current context, thereby enabling state-driven reconfiguration of generative behavior.

The parameter selector 504-1 selects or computes values for one or more operational parameters based on the available user-state and system-state information. For instance, the parameter selector 504-1 may choose an explanation depth level, such as “brief,” “standard,” or “detailed,” depending on the user's mastery progression for the underlying topic and any indications of cognitive overload. As another example, the parameter selector 504-1 may reduce verbosity and increase pacing pauses when engagement instability is detected or may increase scaffolding and step-by-step reasoning when comprehension difficulty or learning instability is identified.

The inference-control parameter set 504-2 comprises configurable parameters that influence the generation process of the generative instructional component 502. In the illustrated example, the inference-control parameter set 504-2 includes parameters corresponding to explanation depth, verbosity, pacing, modality emphasis, language complexity, scaffolding level, response timing, and instructional framing. In other implementations, the inference-control parameter set 504-2 may also include model selection indicators (example, choosing between different specialized generative models), prompt templates, temperature or randomness controls, tokenization, content safety constraints, or persona settings tailored to the user's age and context.

Explanation depth parameters control the extent to which conceptual and procedural detail is included in a generated response. For example, when mastery emergence is detected and predicted outcome indicators suggest a high probability of success, the explanation depth may be set to a lower level, emphasizing concise reinforcement and challenge problems rather than extensive step-by-step guidance. Conversely, when cognitive overload or comprehension difficulty is detected, the explanation depth parameter may drive the generative instructional component 502 to provide more granular breakdowns, concrete examples, and analogies to support understanding.

Verbosity and pacing parameters govern the overall length of the response and the rate at which information is delivered. In one scenario, verbosity may be reduced and pacing adjusted to provide shorter, segmented responses when engagement stability measures indicate risk of attentional drift, thereby allowing the user to consume content in smaller chunks. In an alternative implementation, when the user has indicated a preference for thorough explanations, and engagement appears stable, verbosity may be increased, and pacing may allow denser information delivery with optional “show more detail” affordances.

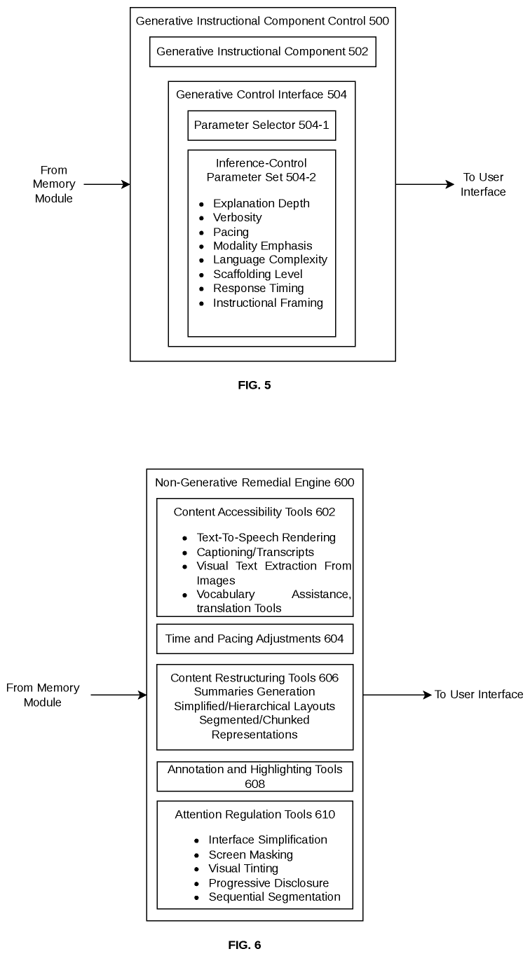

Modality emphasis parameters determine which modalities (for example, text, audio, visual, symbolic) the generative instructional component 502 should prioritize when constructing an instructional response. For example, when preference attributes indicate that the user frequently uses audio and captions, a modality-focused approach may favor succinct textual explanations accompanied by generated audio narration or visual diagrams. In some implementations, modality emphasis settings may also coordinate with the non-generative remedial engine (as explained in detail in FIG. 6) to ensure that generated content is compatible with accessibility tools such as text-to-speech and screen readers.

Language complexity parameters control the reading level, vocabulary, and syntactic complexity of generated text. For instance, if the user is identified as a novice user at a particular grade level, the parameter selector 504-1 may choose a simplified language complexity setting that avoids advanced jargon and uses shorter sentences. In other examples, when mastery progression data and performance history indicate advanced proficiency, language complexity may be increased to include more formal terminology and more compact mathematical notation, thereby supporting the transition to expert-level materials.

Scaffolding level parameters dictate how much stepwise guidance, hints, and intermediate prompts are incorporated into the generative output. For example, when learning instability is detected, or when the user repeatedly fails on a concept despite multiple attempts, a higher scaffolding level may prompt the generative component to structure responses into incremental steps, with checks for understanding after each step. Conversely, when mastery emergence is inferred, the scaffolding level may be lowered such that the system poses more open-ended questions, encourages self-explanation, or leaves more steps for the user to complete independently.

Response timing parameters influence when and how quickly generative responses are delivered relative to user actions and detected events. In some implementations, response timing may be configured to delay certain interventions until a pattern of difficulty is confirmed, thereby avoiding premature interruption, while delivering immediate micro-feedback when high-severity events such as imminent disengagement are detected. In alternative architectures, response timing parameters may also coordinate with session-level pacing controls, spacing schedules, and reminders to revisit material at optimal times for retention.

Instructional framing parameters specify the pedagogical framing and tone of the generative response. For example, instructional framing may dictate whether an explanation is presented as a direct answer, a guided sequence of questions, a real-world analogy, or a metacognitive prompt that encourages reflection on problem-solving strategies. In some scenarios, instructional framing may also adapt the motivational style (for example, supportive, neutral, challenge-oriented) based on engagement stability measures, preference attributes, and predicted outcome indicators.

The generative control interface 504 may dynamically update the inference-control parameter set 504-2 as new user-state events and system-state information are received from the memory module. For instance, after a generative explanation is delivered, subsequent performance history and explicit feedback may cause the parameter selector 504-1 to adjust explanation depth or scaffolding level for the next interaction. Over longer horizons, these adaptations allow the generative instructional component 502 to maintain an individualized instructional profile tuned to the user's evolving needs and responses.

Although FIG. 5 depicts the parameter selector 504-1 and inference-control parameter set 504-2 as part of a single generative control interface 504. In another example, these functions may be implemented in different layers or services. For example, a policy engine may compute high-level pedagogical strategies (such as “intensify remediation” or “introduce challenge problem”), while a separate formatting layer translates those strategies into concrete generative parameters such as explanation depth, scaffolding level, and language complexity. Regardless of the particular implementation, the generative instructional component control 500 operates to translate rich user-and system-state representations into fine-grained generative behavior that supports responsive, personalized user interaction.

FIG. 6 illustrates a non-generative remedial engine 600 in accordance with an exemplary embodiment of the present invention. The non-generative remedial engine 600 delivers non-generative remedial or accessibility-oriented interventions based on user-state events and system-state information obtained from the memory module, and outputs these interventions to the user interface. The non-generative remedial engine 600 includes content accessibility tools 602, time and pacing adjustments 604, content restructuring tools 606, annotation and highlighting tools 608, and attention regulation tools 610, which may operate individually or in coordinated combinations.

The content accessibility tools 602 are configured to increase perceptual and linguistic accessibility of content without changing its underlying instructional intent. In some implementations, the content accessibility tools 602 include text-to-speech rendering, captioning and transcript generation, visual text extraction from images, and vocabulary assistance or translation tools. For example, when the system-state representations indicate that a user frequently enables text-to-speech and captions, and user-state events show signs of cognitive overload during dense reading passages, the non-generative remedial engine 600 may automatically activate text-to-speech and show synchronized captions to reduce reading load.

Text-to-speech rendering converts on-screen text, including static documents and dynamic explanations, into synthesized audio delivered via the user's device. In one scenario, when a user has indicated a preference for auditory learning or is using the system in hands-free mode, the non-generative remedial engine 600 may selectively read aloud question stems, hints, or summaries while leaving diagrams and equations on the screen. In alternative scenarios, text-to-speech may be combined with adjustable speech rate controls and pause insertion to align with pacing parameters derived from user-state indicators.

Captioning and transcript tools provide synchronized text for audio or video content. For example, when a user interacts with an instructional video and the system detects comprehension difficulty or attentional drift, captioning may be enabled or emphasized, and a full transcript may be made visible with highlight tracking as the video plays. In other implementations, transcripts may be searchable, allowing the user to quickly jump back to relevant sections when memory decay or confusion about a prior segment is detected.

Visual text extraction from images provides machine-readable text representations for text embedded in images, diagrams, or scanned documents. In one example, when a static image contains a complex problem statement or a chart with labels, the non-generative remedial engine 600 extracts the text and makes it selectable, searchable, and compatible with assistive technologies such as screen readers and translation tools. This may be particularly beneficial when user-state events and preference attributes indicate reliance on accessibility tools or a need for enlarged or reformatted text.

Vocabulary assistance and translation tools support users who face language or terminology barriers. For instance, the non-generative remedial engine 600 may enable on-demand definitions, synonyms, or simpler rephrasing of difficult terms when repeated requests for help or explicit “too hard” feedback are detected. In an alternative implementation, translation tools may present side-by-side content in the user's preferred language while preserving key technical terms in the original language to support bilingual learning and gradual terminology acquisition.

The time and pacing adjustments 604 module adjust temporal parameters of content delivery in response to user-state events and representations. In some implementations, time and pacing adjustments 604 may extend response time windows, slow down the playback speed of media, or insert deliberate pauses between content segments when cognitive overload, engagement instability, or processing delays are inferred. For example, if the latency and timing signals show consistently long response times and baseline-crossing detectors indicate prolonged hesitation, the system may automatically grant extended time for tasks or reduce the pace of new content introduction.

The content restructuring tools 606 reorganize the structure and presentation of content to better align with the user's current cognitive state. In the illustrated example, the content restructuring tools 606 include capabilities for summary generation, simplified or hierarchical layouts, and segmented or chunked representations, as well as annotation and highlighting tools 608. For instance, when the processing module detects cognitive overload or learning instability, content restructuring tools 606 may generate a concise summary of the presented material and display it before the user proceeds further.

Summaries generation may produce shorter restatements of key ideas or multi-level summaries at varying lengths and abstraction levels. In one example, when a user repeatedly requests help or shows declining accuracy on a long reading passage, the non-generative remedial engine 600 may generate a brief bullet-point summary and a slightly longer paragraph-level summary to provide multiple entry points back into the material. In alternative examples, the length and detail of summaries may be conditioned on confidence values associated with detected events and on preference attributes indicating whether the user prefers high-level overviews or more detailed recaps.

Simplified or hierarchical layouts reorganize complex pages into clearer structures. For example, a dense multi-column article or problem sheet may be transformed into a single-column layout with headings, subheadings, and collapsible sections, making it easier for users experiencing attentional drift or comprehension difficulty to follow. Segmented or chunked representations may break long content sequences into discrete steps or panels, revealing one chunk at a time in alignment with pacing and scaffolding preferences.

The annotation and highlighting tools 608 allow the user or the system to mark important portions of content. In one implementation, the system may automatically highlight key sentences, formulas, or diagram regions when a comprehension difficulty event is detected, guiding the user's attention to the most relevant information. Users may also add their own highlights and notes, which may be stored as part of performance history and system-state representations and later used to inform future interventions or revision sessions.

The attention regulation tools 610 are designed to help mitigate attentional drift, distractions, or visual overload. In the illustrated example, the attention regulation tools 610 include interface simplification, screen masking, visual tinting, progressive disclosure, and sequential segmentation, which may be selectively activated based on engagement stability measures and user-state events. For example, when variability in interaction patterns and long idle times suggest attentional drift, the system may simplify the interface to show only essential controls and currently relevant content.

Interface simplification may hide non-essential UI elements, sidebars, or competing panels to reduce cognitive load. Screen masking may dim or obscure peripheral content areas while keeping a focal region fully visible, thereby directing the user's attention to the current problem, paragraph, or diagram. Visual tinting may subtly adjust background colors or contrast to reduce visual strain, particularly for users who have displayed patterns consistent with fatigue or who have configured accessibility preferences for reduced brightness or specific color themes.

Progressive disclosure reveals information gradually rather than all at once. For instance, a multi-step worked example may initially show only the first step, with subsequent steps revealed upon user action or after confirming understanding, aligning with higher scaffolding levels and minimizing initial overload. Sequential segmentation similarly enforces a stepwise flow through content, ensuring that the user engages with each part in order and reducing opportunities for unstructured skimming when engagement instability is detected.

The non-generative remedial engine 600 may receive user-state representations and system-state information from the memory module and coordinate its actions with other responsive components. In some implementations, the non-generative remedial engine 600 operates under policies that specify when to escalate remedial intensity (example, activating multiple tools simultaneously), when to maintain the current configuration, and when to de-escalate as user-state indicators improve. In alternative architectures, the non-generative remedial engine 600 exposes APIs or configuration interfaces that allow administrators, instructors, or external systems to define custom tool combinations and activation rules tailored to particular populations or contexts.

Although FIG. 6 depicts the content accessibility tools 602, the time and pacing adjustments 604, the content restructuring tools 606 with the annotation and highlighting tools 608, and the attention regulation tools 610 as part of a single non-generative remedial engine 600. In other implementations, these components may be implemented as separate services or plug-ins. For example, a standalone accessibility layer may provide text-to-speech, captioning, and visual text extraction, while a separate learning support layer handles summaries and hierarchical restructurings, and an attention management layer controls interface simplification and screen masking. Regardless of the specific implementation, the non-generative remedial engine 600 delivers state-driven, non-generative interventions that complement the generative instructional component and collectively support responsive user interaction.

FIG. 7 illustrates a static content transformation subsystem 700 within a remedial engine in accordance with an exemplary embodiment of the present invention. The static content transformation subsystem 700 within the remedial engine converts static or inaccessible content into interactive, navigable, and annotatable representations suitable for responsive user interaction and accessibility tools. The subsystem 700 receives static content input 702 and processes it through a transformation module 704, which outputs transformed content to the user interface in formats compatible with screen readers, navigation controls, and other responsive components.

Th static content input 702 represents one or more types of content that are initially presented in fixed or low-accessibility formats. The static content input 702 may include PDFs, image-only documents, spreadsheets, presentations, and graph or chart objects, although other formats such as scanned worksheets, slide decks, or snapshot images of whiteboards may also be supported. In some implementations, these inputs are obtained directly from content units, user uploads, institutional repositories, or external content sources integrated into the system.

The transformation module 704 performs a sequence of processing steps to convert the static content into a structured, navigable representation. The transformation module 704 includes an OCR and text-extraction unit 704-1, a structural-analysis unit 704-2, a reflow and navigable-representation generator 704-3, and a math-visualization and digitization unit 704-4. These components may be executed in a pipeline, with outputs of earlier stages serving as inputs to later stages or selectively invoked based on the input content type and the user's accessibility needs.

The OCR and text extraction unit 704-1 applies optical character recognition and related techniques to identify and extract textual content and basic layout information from static sources. For example, when a user opens a scanned PDF of a textbook page, the OCR and text extraction unit 704-1 converts the text into machine-readable form, capturing paragraphs, headings, page numbers, and inline labels from diagrams or charts. In an alternative implementation, this OCR and text extraction unit 704-1 may also detect language, fonts, and basic typographic emphasis (such as bold or italic) to preserve semantic cues useful for later restructuring and accessibility rendering.

The structural analysis unit 704-2 infers higher-level document structure from extracted text and layout cues. In one example, the structural analysis unit 704-2 identifies sections, subsections, bullet lists, tables, figure captions, and footnotes within a multi-page document, and associates each element with its hierarchical relationships. For spreadsheets or presentations, the structural analysis unit 704-2 may interpret rows, columns, sheets, slide boundaries, speaker notes, and visual groupings, enabling downstream tools to reference and navigate content at an appropriate granularity.

The reflow and navigable representation generator 704-3 creates an interactive representation of the content that may be presented via the user interface in a flexible, accessibility-friendly manner. For instance, a two-column PDF article may be transformed into a single-column, responsive layout that supports text resizing, screen-reader navigation via headings, and keyboard-based traversal of sections. In other implementations, the reflow and navigable representation generator 704-3 may produce semantic markup (such as HTML-like or structured document models) that allows the system to insert annotations, highlights, summaries, or stepwise segmentation in coordination with the non-generative remedial engine and the generative instructional component (as explained in FIGS. 5 and 6).

The math visualization and digitization unit 704-4 focuses on mathematical content and related symbolic structures embedded in the static input. In some implementations, this math visualization and digitization unit 704-4 detects equations, formulas, numerical relationships, and graph or chart elements, and converts them into digitized mathematical expressions and structured data. For example, an image-only worksheet containing algebraic expressions and coordinate-plane graphs may be transformed into markup-based equations and data series that may be manipulated, read by screen readers, or passed to computational engines for interactive exploration.

Digitized mathematical expressions produced by the math visualization and digitization unit 704-4 may be represented in standard machine-readable formats (such as MathML-like structures or symbolic expression trees), enabling fine-grained accessibility and interaction. Numeric relationships extracted from tables or plotted graphs may be converted into data points, functions, or inequalities that the system may use to generate alternative representations, such as numerical tables, interactive sliders, or dynamically rendered plots. Symbolic representations enable the system to support features such as stepwise solution reveal, symbolic manipulation hints, and targeted highlighting of specific terms in response to detected user-state events, such as comprehension difficulty.

In some implementations, the transformation module 704 may further perform semantic segmentation, key-concept extraction, figure interpretation, table restructuring, and instructional sequence generation to convert static instructional materials into adaptive learning objects responsive to detected user states.

Graphs and charts suitable for interaction or screen readers are generated by translating static graph or chart objects into structured descriptions and interactive visualizations. For example, a bar chart embedded in a presentation slide may be made accessible by adding keyboard-focusable elements, descriptive alt-text, and a corresponding data table that is navigated cell by cell. In an alternative implementation, the system may generate multiple views of the same data, such as a summarized verbal description, a detailed tabular view, and an interactive chart, and select among them based on user preferences, accessibility needs, and detected cognitive load.

The transformed content produced by the transformation module 704 is provided to the user interface in coordination with other responsive components. In one scenario, when a user with known accessibility needs opens a scanned exam paper, the subsystem 700 automatically converts it into a navigable, text-based representation with digitized math expressions, enabling the non-generative remedial engine to operate effectively with text-to-speech, highlighting, and progressive disclosure tools. In other implementations, transformed content may also be used as input to the generative instructional component, which may then reference specific sections, equations, or chart elements when generating explanations, summaries, or alternative problem variants.

Although FIG. 7 depicts OCR and text extraction, structural analysis, reflow, and navigable representation generation, and math visualization and digitization as components of a single transformation module 704. In other scenarios, these functionalities may be distributed across separate services or partially offloaded to external tools. For example, a cloud-based OCR service may provide initial text and layout extraction, while on-device components perform structural analysis and reflow to meet latency and privacy requirements. Regardless of the deployment, the subsystem 700 transforms static or inaccessible content into formats that support interactive, state-responsive, and accessible user experiences across the system.

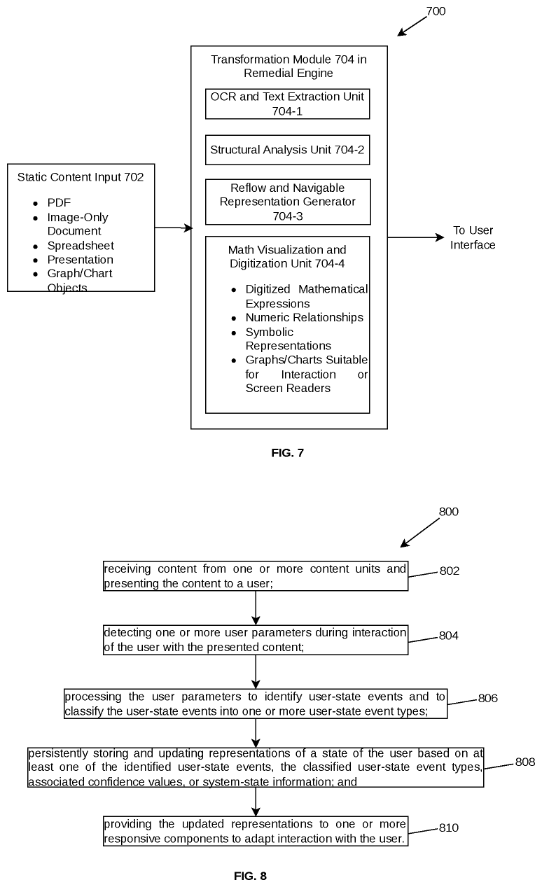

FIG. 8 illustrates a flowchart of method 800 for responsive user interaction in accordance with an exemplary embodiment of the present invention. The method 800 describes a structured sequence of operations through which a system dynamically interprets user behavior and continuously adapts the interaction experience based on detected user states. The method 800 includes several processing stages that collectively enable real-time monitoring, interpretation, storage, and utilization of user-related information to support responsive system behavior.

In an initial step, the method 800 comprises receiving 802 contents from one or more content units and presenting the content to a user. In this stage, the method 800 obtains content that may originate from multiple content units. These content units may correspond to independent sources, modules, or repositories that generate or deliver information intended for user consumption. Upon receiving 802 the content, the method 800 presents the content to the user through an appropriate interface, thereby enabling the user to interact with the presented material. The presentation may occur through any suitable medium or device capable of delivering the content and facilitating user engagement.

Following the presentation of the content, the method 800 proceeds with detecting 804 one or more user parameters during interaction of the user with the presented content. During this stage, the method 800 monitors the user's interaction with the content and captures various user parameters as the interaction occurs. The detected user parameters are observable indicators of the user's behavior, responses, or engagement during interaction with the presented content. The detection process may involve collecting signals or data generated during the interaction, which serve as inputs for subsequent analysis and interpretation within the system.

Subsequently, the method 800 includes processing 806 the user parameters to identify user-state events and classify them into one or more user-state event types. In this step, the method 800 analyzes the detected user parameters to derive meaningful insights regarding the user's interaction state. By processing 806 of the collected parameters, the method 800 identifies user-state events corresponding to specific occurrences or conditions associated with the user during the interaction. Once identified, these user-state events are further categorized into one or more user-state event types. The classification process organizes the detected events into defined categories, facilitating consistent interpretation and enabling subsequent system actions based on the identified event types.

After identifying and classifying the user-state events, the method 800 further comprises persistently storing and updating 808 representations of the user's state. The system maintains persistent representations that reflect the user's current or evolving state during interaction. These representations are continuously updated based on one or more factors, including the identified user-state events, the classified user-state event types, associated confidence values, or system-state information. The persistent storage mechanism ensures that user state representations are retained and updated over time, enabling the method 800 to maintain a historical and contextual understanding of the user's interaction state.

Finally, the method 800 includes providing 810 the updated representations to one or more responsive components to adapt interaction with the user. In this stage, the method 800 communicates the updated user-state representations to responsive components configured to adjust or modify their interaction with the user. Based on the provided representations, the responsive components dynamically adapt the interaction, enabling the method 800 to tailor its behavior and responses to the detected user state. This adaptive process enhances the method's 800 responsiveness and supports more effective, context-aware user interaction.

Through the sequential execution of the steps described above, method 800 enables a system to continuously observe user interactions, interpret user-related signals, maintain up-to-date representations of user state, and use these representations to drive responsive adaptations throughout the interaction. The flowchart in FIG. 8 thus illustrates an integrated framework that enables responsive user interaction by continuously detecting, processing, storing, and utilizing user state information.

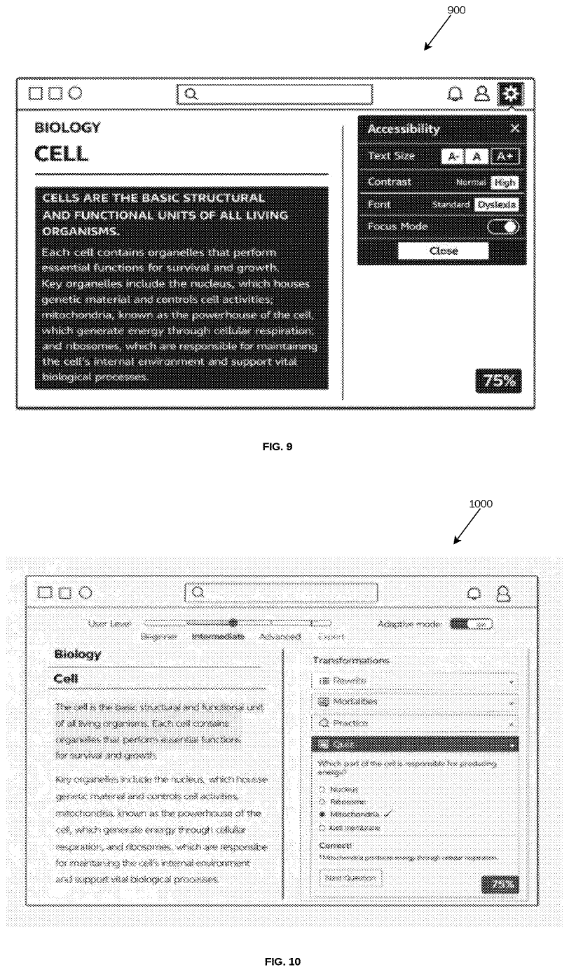

FIG. 9 illustrates a user interface 900 presenting instructional content associated with a topic, together with accessibility controls that enable adjustment of visual presentation parameters in accordance with an exemplary embodiment of the present invention. The user interface 900 illustrates how the system presents instructional content for a topic such as “Biology Cell”. The displayed content may include explanatory text describing that cells are the basic structural and functional units of living organisms, and may further describe organelles, including the nucleus, mitochondria, and ribosomes.

An accessibility panel on the user interface 900 is presented concurrently with the instructional content. The accessibility panel may include adjustable controls such as Text Size, Contrast, Font selection, and Focus Mode. These controls allow the system to adapt the visual presentation of the content based on user preferences or detected user state events. For example, the system may dynamically increase text size or adjust contrast when interaction signals indicate reduced readability or engagement.

FIG. 10 illustrates a user interface 1000 that enables adaptive interaction, in which instructional content is presented together with a transformation panel and an adaptive quiz to evaluate user comprehension, in accordance with an exemplary embodiment of the present invention. The transformations panel may include selectable options such as Rewrite, Modalities, and Practice.

In the illustrated example, the system presents a Quiz related to the displayed content. For example, the user interface 1000 may present a question such as “Which part of the cell is responsible for producing energy?” The user may select from options including Nucleus, Ribosomes, or Mitochondria. Upon receiving the user selection, the system evaluates the response and provides feedback indicating the correct answer. Interaction parameters, such as response accuracy and response latency, may be recorded and used to update a progress indicator that displays completion metrics, such as 75% progress.

FIG. 11 illustrates question generation on a user interface 1100 that provides multiple questions of varying difficulty levels and optional answer-reveal controls in accordance with an exemplary embodiment of the present invention. The user interface 1100 generates multiple questions associated with the instructional topic. The user interface 1100 may present questions of varying difficulty levels, including foundational questions such as “What is the nucleus responsible for?” and more advanced prompts such as “Explain how ATP is produced in cells”.

Each question may include a “Show Answer” control allowing the user to reveal explanatory responses when needed. The system may monitor interaction signals during this process to detect user-state events such as comprehension difficulty or mastery progression and may adjust the difficulty or sequencing of subsequent questions accordingly.

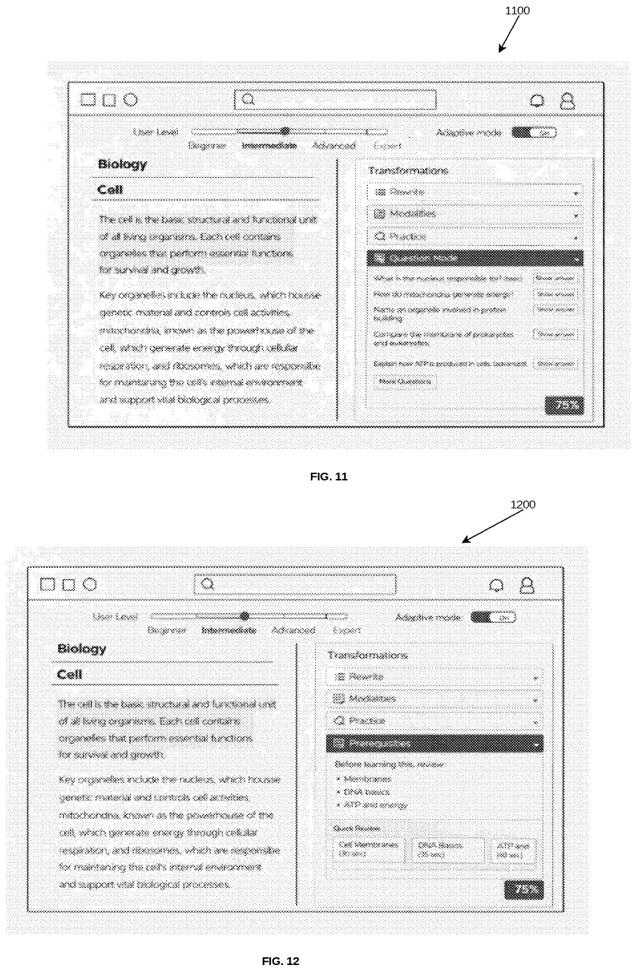

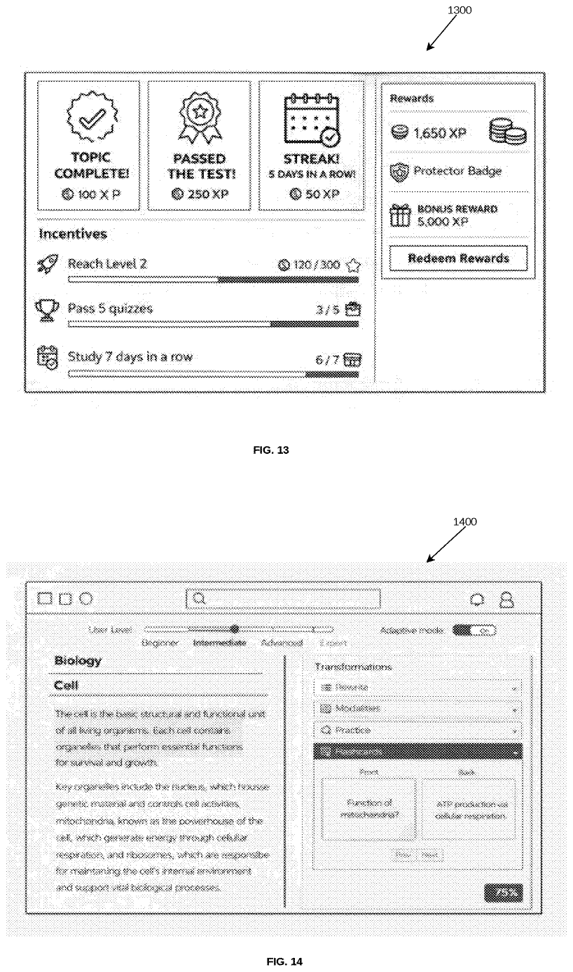

FIG. 12 illustrates a prerequisite review on a user interface 1200 that presents prerequisite concepts and quick-review modules associated with a selected topic in accordance with an exemplary embodiment of the present invention. The user interface 1200 presents prerequisite concepts associated with the currently selected topic. For example, when the user is studying Cell, the system may present prerequisite topics such as Membranes, DNA Basics, and ATP and Energy.

The user interface 1200 may also include “Quick Review” modules that allow the user to revisit foundational material before proceeding to more advanced content. In some examples, the system may automatically present these prerequisite modules when detected interaction signals indicate knowledge gaps or uncertainty.

FIG. 13 illustrates rewards and incentives on a user interface 1300 that present achievements, progress indicators, and redeemable rewards associated with user interaction with the learning system, in accordance with an exemplary embodiment of the present invention. The rewards and incentives are presented after the completion of learning activities. The user interface 1300 may display achievements, including Topic Complete, Passed the Test, or a Streak representing consistent study behavior.

The system may also present progress indicators associated with goals such as Reach Level 2, Pass 5 Quizzes, or Study 7 Days in a Row. Additional elements may include accumulated experience points (XP), achievement badges such as a Protector Badge, and a Redeem Rewards option. These features may encourage sustained engagement and provide additional signals for modeling user interaction patterns.

FIG. 14 illustrates a flashcard interaction in a user interface 1400 that presents flashcards for rapid review of key concepts in accordance with an exemplary embodiment of the present invention. In the flashcard's mode, key concepts are presented as flashcards for rapid review. Each flashcard may display a prompt on a first side and an answer on a second side.

For example, the flashcard may present the prompt “Function of mitochondria?” and the reverse side may display the answer “ATP production via cellular respiration”. Navigation controls such as “Prev” and “Next” allow the user to cycle through flashcards associated with the topic.

FIG. 15 illustrates a deep-dive exploration of a user interface 1500 that expands on a selected concept by providing additional explanatory content and visual representations in accordance with an exemplary embodiment of the present invention. For example, when the user selects the concept “Mitochondria”, the user interface 1500 may display expanded descriptions and visual representations of the organelle.

Additional bullet points may explain that mitochondria generate energy through ATP production and contain their own DNA, similar to bacteria. This deep-dive functionality enables the system to provide more detailed explanations when the user shows interest in a specific concept.

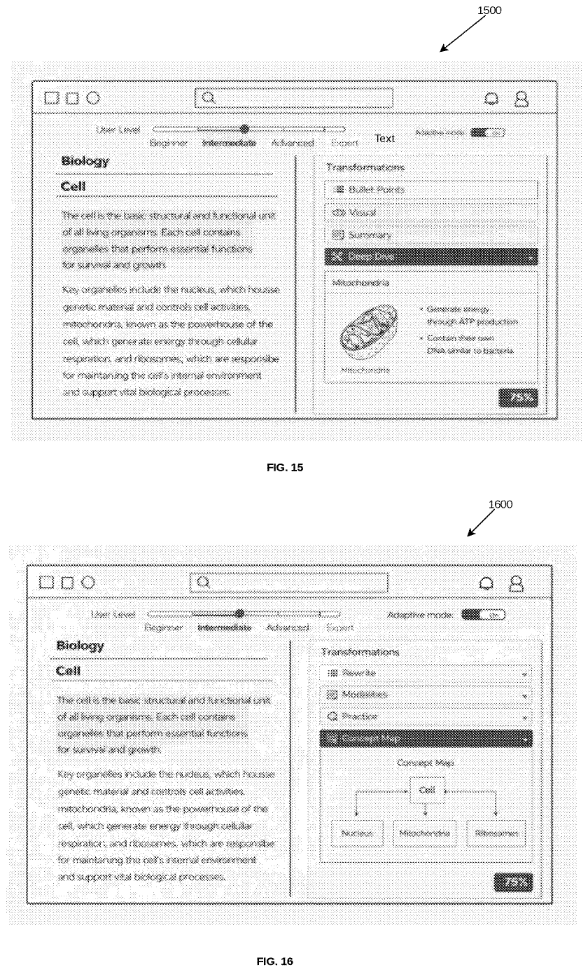

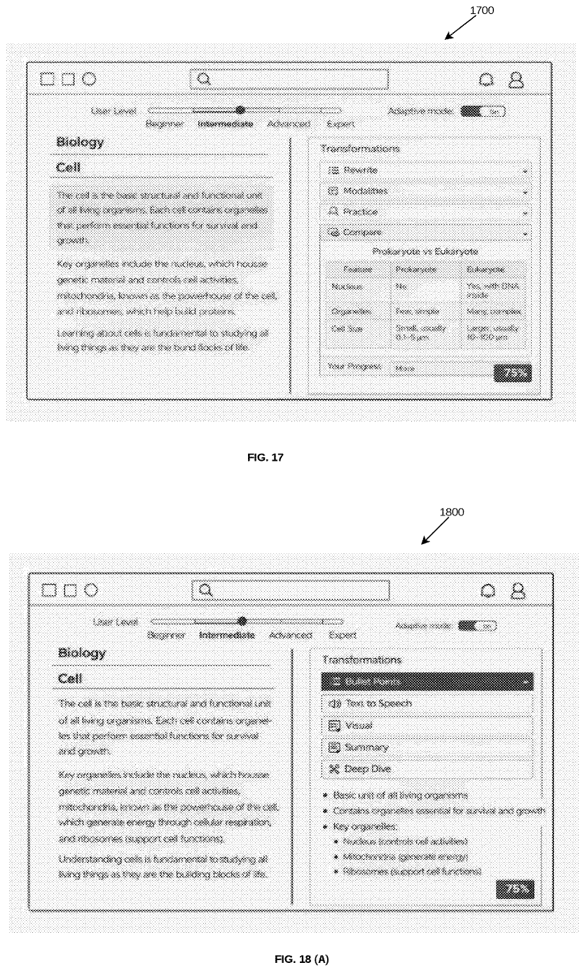

FIG. 16 illustrates a concept map of a user interface 1600 that graphically represents relationships among multiple concepts associated with a selected topic in accordance with an exemplary embodiment of the present invention. The concept “Cell” appears as a central node connected to related components such as “Nucleus”, “Mitochondria”, and “Ribosomes”.

The concept map visually illustrates relationships between biological structures and allows users to explore connections between related concepts. In some embodiments, the system may dynamically generate the concept map based on detected interaction states or learning progression.

FIG. 17 illustrates a user interface 1700, presenting structured comparisons between related concepts in accordance with an exemplary embodiment of the present invention. The user interface 1700 provides the compare transformation that presents structured comparisons between related concepts. In one example, the user interface 1700 presents a comparison between “Prokaryotic cells” and “Eukaryotic cells”.

The user interface 1700 may display a structured table comparing features, including the presence of a nucleus, organelle complexity, and cell size. Such comparative representations allow users to evaluate similarities and differences between concepts in a structured format.

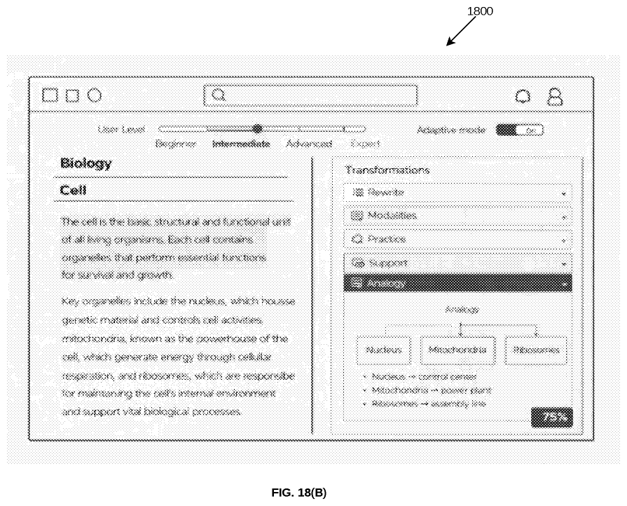

FIGS. 18(A) and 18(B) illustrate a multimodal transformation presented on a user interface 1800, providing alternative representations of instructional content, including summaries, bullet points, visualizations, and analogy-based explanations, in accordance with an exemplary embodiment of the present invention. The user interface 1800 may include Bullet Points, Visual Diagrams, Text-to-Speech Output, Summaries, Deep Dives, and Analogy-Based Explanations.

The user interface 1800 may also present Analogy-based explanations, such as describing the nucleus as a control center, mitochondria as a power plant, and ribosomes as an assembly line. These analogy-based explanations help users understand complex concepts by relating them to familiar structures.

While not illustrated, another exemplary scenarios taught provides for an adaptive incentive engine integrated with a responsive learning platform. The system generates personalized incentives by analyzing learner data obtained from a dynamic learner profile and a learning-state detection framework. The incentive system dynamically generated and aligned with the learner's knowledge state, engagement behavior, and learning progression.

In one example, the platform includes a user model representing the current learner profile and behavioral context. The user model aggregates signals describing the learner's knowledge, engagement, and learning dynamics. These signals may be derived from the dynamic learner profile and from learning-state detection subsystems that process performance and interaction data generated during learner interactions with learning content.

The user model may include, without limitation, representations of learner level classifications including beginner, intermediate, advanced, or expert historical learner level classifications, topic-level mastery estimates, engagement metrics including time spent studying, number of interactions, type of interaction, UI elements interacted with, historical interaction patterns and session activity patterns, review schedules including spaced repetition timing and overdue reviews, detected learning gaps and conceptual weaknesses, historical performance signals, assessment outcomes including quiz and test results, learner preference representations, and system-state information including prior interventions, prior incentives delivered, and learner responses to those incentives.

In one example, learner state information derived from the learning-state detection framework constitutes a primary input to the adaptive incentive engine. The learner-state information may include detected and classified learning-state events, along with associated confidence values that indicate the reliability of those classifications.

Learner-state classifications may include, without limitation, precursor learning states indicative of emerging learning difficulty, adverse learning states corresponding to active learning breakdown or cognitive overload, mastery states representing stable conceptual understanding, and engagement decay states indicative of declining learner attention or motivation. Additional meta information included with learner-state classifications may encompass historical learner-state classifications and associated historical confidence values.

The adaptive incentive engine includes an incentive analyzer configured to evaluate the user model and determine which incentives to generate for the learner. The analyzer may perform operations including identification of learning gaps, evaluation of learner engagement patterns, detection of review opportunities associated with spaced repetition schedules, assessment of recent quiz or test outcomes, interpretation of detected learner states and associated confidence values, and evaluation of system-state information, including prior incentive delivery and learner response history. Based on these inputs, the Incentive Analyzer determines which incentive types to present, the difficulty level of each incentive, the reward magnitude for each incentive, and the priority among potential incentives.

In some scenarios, incentive generation is governed by a scoring function that integrates multiple components derived from the user model and system context. One example incentive scoring formulation may be expressed as: incentive_score=w1×learning_gap+w2×engagement_decay+w3×review_due+w4×mastery_progress+w5×learner_state_factor+w6×system_state_factor+w7×confidence_value, where learning_gap represents the magnitude of detected knowledge gaps, engagement_decay represents recent declines in engagement activity, review_due represents overdue spaced-repetition tasks, mastery_progress represents progress toward higher mastery thresholds, learner_state_factor represents detected and/or historical learner states such as precursor difficulty or mastery, system_state_factor represents system context including prior incentives delivered and time since the last incentive, and confidence_value represents the confidence associated with the detected learner state and/or historical confidence associated with historical detected learner states.

The weights w1 through w7 may be dynamically adjusted by the system based on historical learner outcomes, population-level learning models, or adaptive optimization procedures.

In one example, the incentive score may be used to rank multiple candidate incentives and determine the reward magnitude associated with each challenge.

The incentive generation process may include three stages: computing an incentive priority score, selecting an incentive type, and determining the magnitude or extent of the incentive.

In the first stage, the incentive priority score determines the urgency of presenting an incentive. This score may be derived from the incentive_score formulation described above.

In the second stage, the Adaptive Incentive Engine selects the incentive category to generate. Incentive categories may include focus-area incentives targeting detected knowledge gaps, stretch-goal incentives encouraging advancement toward higher mastery levels, consistency incentives encouraging repeated study behavior, engagement-recovery incentives addressing declining participation, and review-completion incentives encouraging completion of scheduled learning activities.

In one example, incentive type selection may follow a decision logic such as: If learning_gap exceeds a threshold value, generate a focus-area incentive. If mastery_progress_gap exceeds a threshold value, generate a stretch-goal incentive. If engagement_decay exceeds a threshold value, generate a consistency incentive. If an adverse learner state is detected, generate a remedial incentive designed to stabilize learning performance. In the third stage, the adaptive incentive engine determines the magnitude or extent of the incentive. The incentive magnitude may refer to the reward value associated with the challenge or to the challenge's difficulty and duration.

Reward magnitude may be calculated using a reward function such as reward_value=base_reward×(1+α×learning_gap+β×confidence_value), where base_reward represents a baseline reward level, α represents a weighting factor for the severity of the learning gap, and β represents a weighting factor based on confidence in the detected learner state. The system-state information may further adjust reward magnitude to prevent excessive or repetitive incentives. For example: adjusted_reward=reward_value×e\hat{ }(−λ×recent_incentive_frequency), where λ represents a decay factor preventing excessive reward issuance within short time intervals.

In some examples, the incentive score, incentive type, and incentive magnitude may be determined using an artificial intelligence-based classification or prediction system. Such a system may be trained using manually curated training data, machine-generated behavioral logs, or combinations thereof.

Training data may include records representing learner states, engagement metrics, performance signals, prior incentives delivered, and resulting learner outcomes such as improved mastery or increased engagement.

Feature vectors used for training may include variables such as learner mastery level, engagement activity level, detected learner state, learner state confidence values, recent quiz scores, system-state parameters, and prior incentive responses.

Corresponding training labels may include recommended incentive types, recommended reward magnitudes, or challenge parameters that have historically led to improved learner engagement or mastery progression.

Suitable machine learning models may include decision-tree classifiers, random forests, gradient-boosted models, neural networks, probabilistic graphical models, reinforcement learning models, or deep learning architectures.

In some cases, a reinforcement learning system may treat incentive generation as a sequential decision problem, selecting incentives to maximize long-term learning outcomes. A reinforcement learning reward function may be expressed as: system_reward=α×mastery_improvement+β×engagement_increase+γ×task_completion_rate, where mastery_improvement represents increases in mastery estimates, engagement_increase represents improved participation levels, and task_completion_rate represents successful completion of learning tasks.

The adaptive incentive engine generates personalized challenges designed to guide learner behavior. These challenges may include focus-area challenges targeting detected knowledge gaps, stretch goals encouraging advancement beyond the learner's current mastery level, consistency challenges promoting regular study habits, and review challenges encouraging completion of spaced repetition activities.

Examples include Focus Area Challenge: Review mitochondria, Reward: +120 XP, Stretch Goal: Reach 80% mastery in Cell Biology, Reward: +200 XP [305][301], Consistency Challenge: Study 3 days this week, Reward: +90 XP, Review Completion Challenge: Complete today's spaced-repetition review, Reward: +75 XP.

Learner-state classifications may directly influence incentive generation. For example, if a precursor learning state is detected with high confidence, the system may generate a targeted focus-area challenge, encouraging review of the concept before learning failure occurs. If an adverse learning state is detected, the system may generate remedial challenges with increased reward magnitude to motivate corrective learning behavior. If a mastery state is detected, the system may generate stretch goals that encourage progression toward more advanced content without degrading the mastery state. If engagement decay is detected, the system may generate consistency challenges, encouraging renewed study activity.

The system also includes a reward subsystem that delivers incentives upon successful completion of generated challenges. Rewards may include experience points, virtual coins or tokens, achievement badges, learner level progression indicators, unlockable platform features, streak bonuses, or other virtual incentives.

In some cases, accumulated rewards may be exchanged for real-world items or benefits. These benefits may include coffee shop gift cards, digital marketplace credits, educational resource discounts, merchandise, or other redeemable items. By allowing virtual rewards to be exchanged for real-world items, the system strengthens motivational incentives and encourages sustained learner participation. For example, accumulated rewards may follow a redemption model, 1000 XP corresponding to a five-dollar coffee shop gift card. 2500 XP may correspond to a digital bookstore credit. 5000 XP may correspond to access to premium learning content. 1000 XP may correspond to a $10 deposit into a 529 plan account, towards college tuition.

The adaptive incentive engine operates within a closed feedback loop. When learners complete challenges and receive rewards, the resulting behavioral changes influence learner engagement metrics, mastery estimates, learner-state classifications, and system-state information stored within the dynamic learner profile.

The system-state information may include records of previously delivered incentives, learners' responses to prior incentives, reward redemption history, elapsed time since prior incentive delivery, and the frequency of incentive triggers.

In one example scenario, a learner profile may indicate mastery of approximately sixty-five percent in cellular biology, declining engagement, quiz performance below an expected threshold, and a detected precursor learning state with a confidence value of 0.82. Based on these inputs, the Adaptive Incentive Engine may generate a focus-area challenge encouraging review of mitochondria, a review completion challenge encouraging completion of the day's study session, and a consistency challenge encouraging study on multiple days during the week.

Completing these challenges may earn experience points that accumulate toward redeemable benefits, such as digital gift cards or other incentives.

By integrating learner-state detection, dynamic learner profiling, system-state awareness, machine-learning-assisted decision-making, and adaptive incentive generation, the disclosed system aligns motivational incentives with actual learning progress. Unlike conventional gamification approaches, which reward activity regardless of learning dynamics, the Adaptive Incentive Engine generates incentives that directly target learning gaps, reinforce mastery, and sustain engagement over time.

The architecture, therefore, forms part of a broader closed-loop learning system in which learner signals are processed by a learning-state detection framework, incorporated into a dynamic learner profile, used to drive adaptive instructional interventions, and further used to generate state-aware incentives that influence learner behavior. The resulting behavioral changes generate new signals that continuously update the learner profile and drive subsequent detection, intervention, and incentive generation processes.

Through this integrated architecture, the system provides a responsive motivational control mechanism that adapts continuously to the learner's evolving cognitive state, engagement patterns, and learning progress.

In yet another scenario-also not illustrated-a responsive review engine integrated with a responsive learning platform is disclosed. The system generates personalized review schedules by analyzing learner data obtained from a dynamic learner profile and a learning-state detection framework. The review system dynamically determines when and how review activities should be delivered to maintain conceptual stability and reinforce knowledge retention.

In one scenario, the responsive review engine operates using a review model derived from the dynamic learner profile. The review model aggregates signals describing the learner's knowledge state, engagement behavior, learning stability, and review history.

The review model may include, without limitation, representations of topic-level mastery estimates, historical mastery estimates, historical learner performance signals, detected learner-state classifications and associated confidence values, engagement metrics including interaction frequency and session duration, review history including prior review attempts and outcomes, time since last exposure to specific learning content, assessment outcomes including quiz results and examination scores, learner preference representations, topic exposure history representing topics and sub-topics covered by the learner, and system-state information including prior review scheduling patterns and learner response to prior review activities.

Learner-state information derived from the learning-state detection subsystem may constitute a primary input to the responsive review engine. The learner-state information may include detected and classified learning-state events, along with associated confidence values indicating the reliability of those classifications.

Learner-state classifications may include, without limitation, precursor learning states indicative of emerging learning difficulty, adverse learning states corresponding to active learning breakdown or cognitive overload, mastery states representing stable conceptual understanding, and engagement decay states indicative of declining learner attention or motivation.

Assessment outcomes such as quizzes, practice tests, and examinations may also provide important signals regarding learner understanding. Assessment signals represent high-confidence indicators of knowledge state because they often measure learner performance under structured evaluation conditions.

Assessment-derived signals may include quiz accuracy rates across topics or sub-topics, exam scores and percentile rankings, question-level correctness distributions, error-type classifications including conceptual errors, procedural errors, and computational mistakes, response latency during assessment tasks, confidence ratings associated with learner responses, and temporal patterns in assessment performance across multiple evaluations.

The responsive review engine evaluates the review model to determine which learning topics should be reviewed, how often those topics should be repeated, the interval between review sessions, and the modality of review activities to present.

In one case, the responsive review engine computes a review priority score representing the urgency of reviewing a particular topic. An example formulation may be expressed as: review_priority=w1·knowledge_decay+w2·learning_gap+w3·performance_instability+w4·engagement_decay+w5·time_since_last_review+w6·learner_state_factor+w7·confidence_value+w8·assessment_performance_gap, where knowledge_decay represents estimated memory decay associated with the topic, learning_gap represents detected conceptual weaknesses, performance_instability represents variability in learner performance across related content units, engagement_decay represents declining learner activity levels, time_since_last_review represents elapsed time since the topic was last reviewed, learner_state_factor represents detected learner states such as precursor difficulty or adverse learning states, confidence_value represents the reliability of the detected learner-state classification, and assessment_performance_gap represents deviations between expected and observed performance on quizzes or examinations.

Topics associated with higher review_priority scores may be scheduled for earlier review.

The responsive review engine may also determine the frequency of repetition for review activities. Repetition frequency determines how often a topic should be revisited within a defined time period.

The repetition frequency may be computed using a formulation such as: repetition_frequency=base_frequency×instability_factor×assessment_gap_factor×confidence_factor, where base_frequency represents a baseline repetition rate, instability_factor represents performance variability associated with the topic, assessment_gap_factor reflects deviations observed in quiz or exam performance, and confidence_factor reflects the reliability of the learner-state detection.

Topics associated with unstable performance signals or precursor learning states may therefore be repeated more frequently until conceptual stability improves.

The responsive review engine may also determine the interval between review sessions. One example formulation is: review_interval=base_interval×mastery_stability_factor×confidence_factor, where base_interval denotes a baseline review interval, and mastery_stability_factor reflects the stability of learner performance signals for the topic.

If mastery stability and confidence in the mastery classification are high, the review interval may increase. Conversely, if performance instability or precursor learning states are detected, the review interval may decrease so that the topic is revisited sooner.

In one case, the responsive review engine maintains a structured representation of learning content previously encountered by the learner. This representation may include topics, sub-topics, concept clusters, and individual knowledge elements associated with learning content units previously presented to the learner.

The dynamic learner profile may therefore include a topic exposure map that represents the set of topics and subtopics covered by the learner over time. Each topic or sub-topic may be associated with mastery estimates, performance variability measures, learner-state classifications, and assessment outcomes.

The responsive review engine may use this topic exposure map to identify specific regions of conceptual weakness within a topic hierarchy.

For example, cellular biology may include subtopics such as mitochondria, ribosomes, membrane transport, and cellular respiration. Each sub-topic may further contain concept-level elements such as ATP synthesis, proton gradients, electron transport chains, or enzymatic reactions.

In one case, the review engine may compute a weakness score for each concept or sub-topic based on learner performance signals, detected and/or historically detected learner states, and assessment outcomes.

An example formulation may be expressed as: weakness_score=a1·error_rate+a2·performance_instability+a3·assessment_gap+a4·precursor_state_probability+a5·time_since_last_success.

Concepts or sub-topics with the highest weakness_score values may be prioritized for review.

The responsive review engine may dynamically narrow review activities to the weakest concept within a sub-topic. For example, if a learner studying cellular respiration demonstrates instability specifically in the electron transport chain, the review engine may schedule review activities focused on that concept rather than repeating the entire cellular respiration topic.

The review engine may also recommend supplemental learning resources associated with the identified areas of weakness. Such resources may include additional instructional explanations, worked examples, visual diagrams, conceptual maps, short explanatory videos, practice exercises, or interactive simulations.

In one case, the platform may employ large language models to generate customized instructional materials for weak concepts. Such materials may include summarized explanations of the concept, simplified explanations suitable for beginner-level understanding, conceptual maps illustrating relationships among key ideas, and analogical explanations, such as simplified “explain like I'm five” representations, designed to clarify complex concepts using intuitive language.

For example, if a learner demonstrates instability in ATP synthesis in the mitochondria topic, the system may generate a conceptual map showing the relationships among the electron transport chain, proton gradients, ATP synthase, and energy transfer. The system may also generate simplified explanations describing the process in intuitive terms suitable for learners at different conceptual levels.

The responsive review engine may further determine the type or modality of review activity to present. Review modalities may include flashcards for rapid recall reinforcement, quizzes to assess conceptual understanding, practice tests to simulate assessment conditions, worked-problem exercises, or mixed review sessions that combine multiple content formats.

Flashcards may be used to reinforce recall of vocabulary, definitions, or key concepts. Quizzes may be used to evaluate conceptual relationships and identify learning gaps. Practice tests may be used to verify mastery of complex topics or simulate examination conditions.

For example, if quiz results reveal recall errors, the system may schedule flashcard-based review. If conceptual misunderstandings are detected, the system may deliver targeted quizzes with explanatory feedback. If exam performance reveals procedural weaknesses, the system may schedule practice problems or worked examples. If performance variability suggests conceptual instability, the system may deliver mixed-format review sessions combining flashcards, quizzes, and practice tests.

The responsive review engine may also dynamically adjust difficulty. review_difficulty=base_difficulty+difficulty_adjustment, where difficulty_adjustment depends on learner-state classifications, engagement patterns, or recent assessment outcomes.

When mastery states are detected, the goal is to encourage deeper conceptual understanding. When adverse learning states are detected, review difficulty may decrease, and additional instructional scaffolding may be provided.

The responsive review engine may also integrate review scheduling with a learner's calendar and study planning system.

In one case, the system may access calendar data indicating scheduled examination dates, assignment deadlines, or study plan milestones. The review engine may use this information to schedule review sessions to support upcoming assessments.

For example, if an examination date approaches, the review engine may increase the frequency of repetition for topics included in the exam syllabus and schedule review sessions closer to the exam date. Conversely, if a concept has been mastered and no near-term evaluation is scheduled, the review engine may extend the review interval.

The system may also adjust review scheduling according to individualized study plans specifying target learning milestones, preferred review windows, pacing constraints, and available study time.

In one example, the review engine may generate calendar-based review schedules that allocate review sessions across available study time while balancing topic priority scores, learner engagement patterns, and upcoming evaluation events.

The responsive review engine may also generate structured review sessions combining multiple instructional elements. A review session may include a conceptual summary of the topic, a simplified explanation of key ideas, a conceptual map illustrating relationships among concepts, flashcard-based recall exercises, quiz questions evaluating conceptual understanding, and practice problems verifying procedural knowledge.

In one example scenario, a learner studying cellular biology demonstrates moderate mastery of mitochondrial function with a mastery estimate of sixty-five percent. Over time, the learner's quiz performance becomes inconsistent, and the learning-state detection subsystem identifies a precursor learning state with a confidence value of 0.82.

The responsive review engine may schedule a flashcard review session covering mitochondrial terminology, followed by a quiz assessing conceptual understanding of mitochondrial structure, and then a short practice test verifying comprehension of ATP production.

In another scenario, a learner studying algebra demonstrates stable mastery of linear equations with a mastery estimate of ninety percent and consistent quiz performance. Because of the high mastery stability and high confidence in the mastery classification, the responsive review engine may extend the review interval and reduce repetition frequency, scheduling a mastery confirmation review several weeks later.

The responsive review engine operates independently of any incentive or reward subsystem that may exist within the learning platform. Although both the review engine and the incentive engine may access information stored in the dynamic learner profile, the review engine does not depend on incentives when determining review scheduling decisions.

This architectural separation prevents circular dependencies in which review scheduling might be influenced by incentives that, in turn, depend on review completion.

Instead, the responsive review engine focuses exclusively on knowledge stabilization and learning reinforcement, while the incentive system focuses on learner motivation.

By integrating learner-state detection, dynamic learner profiling, assessment performance signals, repetition-frequency adjustment, responsive review modality selection, sub-topic weakness identification, LLM-generated instructional resources, calendar-aware scheduling, system-state awareness, and optional machine-learning optimization, the responsive review engine provides a responsive and efficient mechanism for reinforcing knowledge retention.

The system dynamically adjusts review scheduling, repetition frequency, review modality, and difficulty based on the learner's evolving cognitive state, assessment performance, and interaction patterns, enabling early intervention when learning instability emerges and reducing unnecessary repetition when mastery is stable.

Through this adaptive approach, the review system improves knowledge retention and supports efficient reinforcement of learning within the broader responsive learning architecture.

Examples, scenarios, or cases are described at least in part herein with reference to flowchart illustrations and/or block diagrams of methods, systems, and computer program products and data structures according to embodiments of the disclosure. It will be understood that each block of the illustrations, and combinations of blocks, can be implemented by computer program instructions. These computer program instructions may be provided to a processor of a general-purpose computer, special-purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus, to produce a computer implemented process such that, the instructions which execute on the computer or other programmable apparatus provide steps for implementing the functions/acts specified in the block or blocks.

In general, the word “module” as used herein refers to logic embodied in hardware or firmware, or to a collection of software instructions, written in a programming language, such as Java, C, etc. One or more software instructions in the unit may be embedded in firmware. The modules described herein may be implemented as either software and/or hardware modules. They may be stored in any non-transitory computer-readable medium or other non-transitory storage elements. Some non-limiting examples of non-transitory computer-readable media include CDs, DVDs, BLU-RAY, flash memory, mobile devices, remote devices, and hard disk drives.

1. A system for responsive user interaction, comprising:
a user interface to receive content from one or more content units and to present the content to a user;
a detection module to detect one or more user parameters during interaction of the user with the presented content;
a processing module to receive the user parameters from the detection module to identify user-state events and to classify the user-state events into one or more user-state event types; and
a memory module to persistently store and update representations of a state of the user based on at least one of the identified user-state events, the classified user-state event types, associated confidence values, or system-state information;
wherein the processing module provides the updated representations received from the memory module to one or more responsive components to adapt interaction with the user.

2. The system according to claim 1, wherein the content comprises at least one of audio content, video content, textual content, image content, audiovisual content, or a combination thereof.

3. The system according to claim 1, wherein the detection module detects precursor user-state events indicative of a potential future adverse outcome prior to observable failure, disengagement, or performance degradation.

4. The system according to claim 1, wherein the one or more user parameters include at least one of question-level accuracy, response latency, interaction frequency, content navigation behavior, input modality, or explicit user feedback signals.

5. The system according to claim 1, wherein the one or more user-state event types include at least one of precursor learning states, engagement instability, comprehension difficulty, cognitive overload, attentional drift, memory decay, learning instability, mastery emergence, or other states indicative of changes in user performance, engagement, or learning proficiency.

6. The system according to claim 1, wherein the processing module receives contextual data including at least one of content difficulty metadata, topic or curriculum context, time of day, session duration, device characteristics, environmental characteristics, or user preference indicators.

7. The system according to claim 6, wherein the processing module performs at least one of normalization, temporal windowing, weighting, baseline adjustment, or feature extraction on the user parameters or contextual data prior to identifying user-state events, and wherein the processed data is represented within a common multi-dimensional spatiotemporal space such that deviations from baseline are reflected as relative positions over time within the space, enabling identification of user-state events based on such relative positioning.

8. The system according to claim 1, wherein the representations of the state of the user include at least one of cognitive state indicators, mastery progression data, engagement stability measures, preference attributes, predicted outcome indicators, performance history data, user-state history data, detection trace references, or system-state representations.

9. The system according to claim 1, wherein the system-state information includes at least one of previously delivered responsive outputs, historical system states, elapsed time since a prior responsive output, output frequency, output effectiveness, or user response to prior outputs.

10. The system according to claim 1, wherein the one or more responsive components comprises a generative instructional component.

11. The system according to claim 10, wherein the processing module adjusts operational parameters of the generative instructional component based on the updated representations.

12. The system according to claim 11, wherein the operational parameters include at least one of explanation depth, verbosity, pacing, modality emphasis, language complexity, scaffolding level, response timing, or instructional framing.

13. The system according to claim 1, wherein the one or more responsive components comprise a non-generative remedial or accessibility intervention engine to deliver interventions based on at least one of the user-state events or the system-state information.

14. The system according to claim 1, wherein the processing module coordinates delivery of outputs to both a generative instructional component and a non-generative remedial or accessibility intervention engine.

15. The system according to claim 14, wherein the non-generative remedial or accessibility intervention engine delivers interventions including at least one of text-to-speech rendering, captioning, visual text extraction, extended time adjustments, vocabulary assistance, translation, highlighting, annotation tools, summaries, or content restructuring.

16. The system according to claim 1, wherein the processing module transforms static or inaccessible content into an interactive, navigable, or annotatable representation presented via the user interface.

17. The system according to claim 16, wherein the transformed content includes visualized or digitized mathematical expressions, numerical relationships, symbolic representations, graphs, or charts.

18. The system according to claim 13, wherein the interventions include attention-regulation tools comprising at least one of interface simplification, screen masking, visual tinting, progressive disclosure, or sequential segmentation.

19. The system according to claim 1, wherein the processing module escalates, maintains, or de-escalates remedial intensity based on changes in the representations of the state of the user over time or space.

20. The system according to claim 1, wherein the processing module generates or delivers a summary of presented content in response to detection of at least one user-state event indicative of cognitive overload, learning instability, or engagement degradation.

21. The system according to claim 1, wherein the processing module reorganizes the content into simplified, hierarchical, or segmented representations in response to the detection of a user-state event indicative of comprehension difficulty or conceptual fragmentation.

22. The system according to claim 20, wherein at least one of a length, level of detail, abstraction level, or modality of the summary is adjusted based on a confidence value or severity associated with the detected user-state event.

23. The system according to claim 1, wherein the processing module updates detection sensitivity, thresholds, or conditioning parameters for identifying user-state events based on historical user responses to prior responsive outputs.

24. A system for determining a user state representation, comprising:
a detection module to acquire user parameters from user interactions with one or more content units;
a processing module to receive the user parameters from the detection module to identify user-state events and to classify the user-state events into one or more user-state event types; and
a memory module to persistently store and update representations of a state of the user based on at least one of the identified user-state events, the classified user-state event types, associated confidence values, or system-state information;
wherein the processing module provides the updated representations from the memory module to a profile framework.

25. A system for state-driven reconfiguration of responsive components, comprising:
a detection module to detect one or more user parameters during user interaction with presented content;
a processing module to receive the user parameters from the detection module to identify and classify the user-state events into one or more user-state event types with associated confidence values; and
a memory module to store user-state representations and system-state information;
wherein the processing module selects a response-configuration parameter based on at least one of the user-state representations or system-state information and provides the selected response-configuration parameter to one or more responsive components configured to adjust operational settings.

26. The system according to claim 25, wherein the response-configuration parameter includes at least one of content modality emphasis, content complexity level, pacing rate, scaffolding intensity, feedback granularity, repetition frequency, or sequencing flexibility.

27. The system according to claim 25, wherein the operational settings include at least one of generative model inference parameters, prompt conditioning attributes, output formatting controls, intervention timing constraints, remedial action intensity levels, accessibility feature activations, or attention-regulation tool configurations.
